(19) United States
(12) Patent Application Publication
(10) Pub. No.: US 2023/0076719 A1
(43) Pub. Date: Mar. 9, 2023

(54) MIXING ASSEMBLY

(71) Applicant: Dionex Softron GmbH, Germering (DE)

(72) Inventors: Christoph STROBL, Munich (DE); Georg HUBER, Weißenfeld (DE)

(21) Appl. No.: 17/929,083

(22) Filed: Sep. 1, 2022

(30) Foreign Application Priority Data
Aug. 20, 2021 (DE) 10 2021 121 631.1

(51) Int. Cl. B01F 31/80; G01N 30/34

(52) U.S. Cl. CPC B01F 31/89; G01N 30/34; B01F 2101/23

(57) ABSTRACT

The present invention relates to a mixing assembly for mixing a fluid, wherein the mixing assembly comprises a fluid accommodation portion configured to accommodate the fluid, and a wave source, wherein the wave source is configured to generate an acoustic wave. The mixing assembly is configured to inject at least part of the acoustic wave into the fluid accommodated in the fluid accommodation portion to thereby cause mixing of the fluid in the fluid accommodation portion. The present invention also relates to a corresponding liquid chromatography system, method and use.

The present invention generally relates to the mixing of fluids. In particular, the present invention concerns an assembly and method for mixing of fluids, e.g. inside of pumps or samplers.

The present invention is described with a particular focus on mixing of fluids in liquid chromatography (LC)—and more particularly high performance liquid chromatography (HPLC). HPLC, and more generally liquid chromatography, is a method of separating samples into their constituent parts, which can be detected and quantified and/or their portions can be stored for subsequent use. However, it will be understood that the present technology may also be used in the context of other applications where mixing of fluids, in particular in micro-fluidics, is performed. Mixing may refer to laminar or turbulent flow and to two-dimensional and three-dimensional mixing scenarios.

The principle of chromatography is based on injecting a sample (e.g., with a sampling unit) into a fluidic path, wherein a mobile phase, e.g. comprising liquid solvents, provided by a pump, transports it to and through a chromatographic column comprising a stationary phase, e.g. a solid porous material. The separation of individual constituents of the sample depends on the interactions between the constituents, the stationary phase and the mobile phase. Generally, the stronger a constituent interacts with the stationary phase, the longer it may take the mobile phase to elute it from the column. These interactions are characteristic to the constituents and thus result in corresponding characteristic retention times for the constituents, which may depend on the specific conditions (e.g. composition of the mobile and stationary phase).

The separation of compounds can be influenced by adjusting the composition of the mobile phase over time, which may be referred to as solvent gradients, where the composition may typically be changed continuously. That is, typically two (or more) different solvents may be combined. The effectiveness of the combination can depend on the mixing efficiency. Thus, fluidic devices such as mixers and proportional valves can be used, wherein the ratio of the two solvents may be changed over time.

In general, the exact knowledge of flows may be advantageous for a good analytical result of an HPLC measurement, as the flow may have a direct influence on analysis speed and reproducibility. In particular, when two or more components are introduced into the system, deviations in component concentration may alter results. Mixing can be used, e.g., to equalize concentrations and/or apply a predetermined amount of mixing to the fluid.

Consequently, a given compound may elute once the solvent composition exceeds a threshold value (e.g. a certain volumetric concentration of solvent A in a blend of solvents A and B). This threshold value may be characteristic for this given compound.

Mixers may achieve mixing through different paths. The flow into the mixer may be divided into paths of different lengths, so that the volume elements of the flow take different lengths of time to pass through the mixer. This initially spatially separates adjacent volume elements that have similar concentration compositions and brings them into adjacency with volume elements that have different concentration compositions. This averages out unintended momentary variations in concentration compositions.

According to the predominant working principles of HPLC pumps, mixers are an additional component adding volume to the system. By design, the mixer has an internal structure, which may comprise a high-pressure seal to the outer atmosphere in case the mixer is used in the high pressure section of the system. Furthermore, a mixer component is limited by chemical compatibility so as to not contaminate the fluid sample and/or corrode due contact with the fluid. The rotary motion causes the liquid in the mixing chamber to swirl and thus be mixed. Because of the movement of a mixing object, i.e. a stirring fish, there is a constant risk of particles being generated by abrasion, which may lead to contamination.

Additional fluid volume may delay the presence of the mixed composition at a separation column and/or detector, leading to increased analysis intervals. A mixer may typically cause large forces in the internal structure of the mixer, which may be taken into account when sealing the mixer. The material of the mixer, the internal structure and the seal must be chemically compatible with the liquids used.

Known assemblies for mixing fluids are generally based on different working principles: Impeller mixers, propeller mixers, turbine mixers, or paddle mixers. Each type of mixer may be powered inductively, magnetically and/or by direct mechanic coupling. Alternatively, the fluid path length can be varied and/or turbulence can be introduced by structures within the flow.

In light of the above, it is an object to overcome or at least alleviate the shortcomings and disadvantages of the prior art. More particularly, it is an object of the present invention to provide a mixing assembly that can be integrated with pumps and provides mixing with minimal fluid volume in the assembly.

These objects are met by the present invention.

In a first embodiment, the present invention relates to a mixing assembly for mixing a fluid. The mixing assembly comprises a fluid accommodation portion configured to accommodate the fluid and a wave source configured to generate an acoustic wave. The mixing assembly is configured to inject at least part of the acoustic wave into the fluid accommodated in the fluid accommodation portion to thereby cause mixing of the fluid in the fluid accommodation portion.

In other words, the mixing assembly may be configured to couple at least a part of the acoustic wave into the fluid that is accommodated in the fluid accommodation portion, and the part of the acoustic wave that has been coupled into the fluid may lead to mixing of the fluid.

The fluid accommodation portion can in particular be a volume that serves a primary purpose which is different from mixing, e.g. a sample container, a piston chamber of a pump, a liquid transporting pipe, a pressure reservoir, a compensation container. Mixing of the fluid can be achieved by acoustically coupling the wave source to the fluid accommodation portion. Thus, the advantage may be achieved that mixing of fluids can be implemented without adding additional components into the fluid flow. Existing fluid volumes can be functionally enhanced to include mixing of the fluid.

Regarding pumps, conventional mechanical mixers can be an additional component that could add additional volume to the system. Such a mixer may comprise an internal structure requiring a high-pressure seal to the outside, thereby potentially introducing a further weak point into a high-pressure fluid system. Additionally, a mixer would need to adhere to the chemical compatibility of the fluid system. By not introducing a separate mixing component or mixing volume into the fluid system, introducing additional seals and/or mechanical mixing components can be avoided.

An additional volume could disadvantageously delay the arrival of a mixture composition at a separation column and/or detector. Therefore, an analysis would be performed with increasingly larger volumes in an increasingly longer processing time. Thus, mixing based on the wave source can advantageously reduce analysis time and or fluid volumes.

Furthermore, an increased mixing volume can cause increased forces or stresses in the internal structure of the mixer, which may necessitate a suitable sealing technique. In particular, materials used in a mixer may be chemically compatible with the liquids used, such that corrosion is prevented and that components dissolved from the materials of the mixer do not interfere with the analysis of the chromatography system. This may not be necessary with the present technology, where already existing fluid accommodation volumes may be used for mixing, without adding a further delay volume.

The liquid accommodation portion can be a volume enclosed by a solid forming a closed chamber, e.g. a pump head in a pump, a mixer or a sample vial. The sound wave propagates through the solid and then impinges on a volume of liquid enclosed by the solid. The sound wave can propagate into the liquid, cause a flow and this flow can mix the fluid.

The wave source may generate the acoustic wave with a frequency in the range of 1 MHz to 1 GHz. Sound propagation in the liquid can occur under the Rayleigh angle θR which is defined by the magnitudes of the sound velocities in the chip substrate vₛ and the liquid v_{f}: sin(θ_{R})=v_{f}/vₛ. The acoustic wave can cause a turbulent flow and/or cavitation in the liquid which enhance mixing.

The wave source may generate the acoustic wave with a power in the range of 10 μW to 10 W.

A sufficient power output can achieve the advantage of generating a flow within the fluid to mix the fluid. In particular, the power transmitted into the fluid by the wave source can be at least an order of magnitude higher than the typical power a sensor using ultrasonic waves to measure a flow can output into the fluid. Furthermore, a flow sensor can be in direct contact with the fluid, wherein the wave source configured to mix the fluid can be shielded from the fluid by a solid substrate, respectively a wall of the fluid accommodation portion. Preferably, the wave source is shielded from the fluid by a metal wall of a pump head.

In a direct-contact-mode, the wave source can be configured to generate an acoustic wave with a power of at least 10 μW (−20 dBm) when the wave source is in direct contact with the fluid. In a transmission mode, the wave source can generate an acoustic wave with a power of at least 100 mW (+20 dBm) when a wall is disposed between the wave source and the fluid. In contrast, an ultrasonic flow sensor may have a maximum output power of 100 nW (−40 dBm).

The fluid may be a liquid, and the mixing assembly may be configured for mixing the liquid in a liquid chromatography system, preferably a high-performance liquid chromatography system or an ion chromatography system.

The wave source may comprise a transducer configured to convert an electrical signal into an acoustic wave, in particular an ultrasonic wave. A propagating sound wave carries acoustic momentum and acoustic energy and can cause acoustic streaming. When a continuous sinusoidal acoustic wave propagates in an inviscid fluid, it forces the fluid elements to oscillate sinusoidally in the wave propagation direction. When the amplitude of the acoustic wave increases, the condition for the superposition principal is no longer valid and a finite amplitude nonlinear acoustic wave is generated. The time-average of the second order of each fluid element's oscillatory velocity has a time-independent (DC) component velocity in addition to a sinusoidal oscillatory velocity. This DC velocity is called “acoustic streaming” which generates a flow in the liquid.

The wave source may comprise a piezoelectric substrate. The piezoelectric substrate can be formed of a piezoelectric ceramic. Charge carriers are shifted in piezoelectric materials under the influence of an electric field, which leads to a change in length (inverse piezoelectric effect). Preferably, the piezoelectric substrate is configured to generate a displacement of up to 10 nm. Amplitudes of an acoustic wave, in particular a surface acoustic wave, can be measured using interferometry. If the applied voltage is an alternating voltage, the particles in a fluid coupled to the piezoelectric substrate start to vibrate and pressure fluctuations occur. Rarefaction of the particles leads to lower pressure, and compression to increased pressure. The wavelength of the sound describes the distance between two rarefaction or compression areas. The resulting sound waves propagate through the surrounding medium, i.e. the fluid or a wall of the fluid accommodation portion. The speed of the sound varies according to the density and the elastic properties of the medium. Examples of typical piezoelectric substrates are: Lithium niobate (LiNbO₃), lithium thantalate (LiTaO₃), quartz, lead zirconium titanate (PZT), gallium arsenide (GaAs), strontium titanate (SrTiO₃), barium titanate (BaTiO₃) and zinc oxide (ZnO).

The piezoelectric substrate may have the form of a chip. The chip can have an even or undulated surface geared towards an optimal propagation of the sound wave. A propagation surface of the chip can be flat and/or continuous. The chip can have a rectangular shape and/or the dimensions of the chip can be based on the resonant frequencies to be generated.

The transducer may comprise an electrically conducting structure which is disposed on the piezoelectric substrate. The electrically conducting structure can form an electrode. Performance of the transducer can be optimized through patterning of electrodes. The electrodes and the electrically conducting structure can form a sandwich structure. In particular the electrically conducting structure can transmit a current or voltage signal to the piezoelectric material. The electrically conducting material can be a sheet of material which is bonded to the piezoelectric material by pressure, vacuum deposition or fusing. The electrically conducting structure may be a metallic structure achieving an increased electrical conductivity.

The electrically conducting structure may be configured to receive an electrical signal, which can be passed to the piezoelectric material to excite an acoustic wave. The transducer can be an electroacoustic transducer configured to convert electrical energy to acoustic energy and vice versa.

The electrically conducting structure may comprise two electrodes. Each electrode may comprise a plurality of electrode strands and the electrode strands may be disposed in an alternating pattern parallel and spaced to each other, to limit the transducer to the excitation of a single resonance frequency. In particular, the transducer can be configured as an interdigital transducer (IDT) formed by two interlocking comb-shaped arrays of metallic electrodes (i.e., in the fashion of a zipper). These metallic electrodes can be deposited on the surface of a piezoelectric substrate to form the periodic structure. An IDT can generate acoustic waves (AW) by generating periodically distributed mechanical forces via the piezoelectric effect. Each electrode strand may be considered to be a discrete source for the generation of AWs in a piezoelectric medium as the piezoelectrically generated stress varies with position near each electrode strand. The electrode strands can be configured in an n-split structure, preferably in a 1-split structure and more preferably in a 4-split structure. The n-split structure can be defined as grouping n electrode strands from a first electrode and grouping n electrode strands from a second electrode, wherein these groups are disposed in an alternating fashion on the piezoelectric substrate. More generally, an m-n-split structure can be defined, wherein an electrode can comprise m groups and each group comprises n-electrode strands. The m groups can be disposed interweaved with groups of a further electrode, which also comprises an m-n-split structure.

The transducer may induce a mechanical displacement of the piezoelectric substrate based on the received electrical signal.

The transducer may have at least one resonant vibration mode which is excitable by the electrical signal and the transducer may be configured to generate a sound wave when the transducer is excited resonantly on the basis of the electrical signal. In particular, the transducer can be limited to one resonant vibration so as to limit the spectral output and focus the energy on generating a single frequency acoustic wave. Alternatively, the acoustic wave can be limited to a selected plurality of resonant frequencies. The excitable resonant frequencies can depend on the configuration of the electrically conducting structure.

The transducer may be configured to generate an acoustic wave (AW), in particular a surface acoustic wave (SAW), which travels along a surface of the chip or a shear wave (SH-SAW) which travels along the surface of the chip and/or through the volume of the chip. The piezoelectric substrate and a fluid disposed on the piezoelectric substrate can have a mismatch of sound velocities regarding AWs. This can achieve the advantage of efficiently transferring AWs into the fluid, creating significant inertial forces and fluid velocities. An SAW can be defined as a Rayleigh wave. A shear wave can also run in the volume and not only on the surface.

The mixing assembly may comprise a solid substrate, wherein the transducer is acoustically coupled to the solid substrate to generate a SAW on a surface of the solid substrate. Thereby, the piezoelectric substrate can be shielded from contact with the fluid by the solid substrate. Furthermore, physical boundary conditions can remain unchanged, i.e., no further materials are introduced into the system when coupling the transducer to the solid substrate, which is in contact with the fluid. A material or a substance disposed on or in contact with a surface of the solid substrate remains unchanged. The fluid can be disposed on the solid substrate but is not in contact with the transducer. Therefore, chemical interaction between the fluid and the transducer can be avoided. Preferably, the transducer is coupled to a surface of the solid substrate which is not in contact with the fluid to be mixed. This may further achieve the advantage that an acoustic coupling between the transducer and the solid substrate can be enhanced by acoustic coupling materials without the requirement of the acoustic coupling materials being inert to the fluid. The transducer can, for example, be bonded to the solid substrate, in particular glued to the solid substrate.

The chip may be configured to decouple and/or refract the acoustic wave from the surface when physical boundary conditions at the surface change, in particular when the medium disposed on the surface changes. There can be a vacuum or air in an upper half-space of the chip. The AW can travel along a partial surface of the chip which is in contact with air, vacuum or generally a less dens fluid than in a further partial surface. The further partial surface can be in contact with or acoustically coupled to a fluid to be mixed. The AW can then be refracted into the liquid at the further partial surface. The further partial surface can be acoustically coupled to the fluid, respectively the liquid accommodation portion comprising the fluid, by a coupling layer. The coupling layer can consist of an acoustic coupling fluid, a coating, an adhesive and/or a titanium comprising layer.

The fluid accommodation portion may be configured as a fluid-tight container having at least one opening. The at least one opening can serve as an entry port for liquid to fill the container or to pressurize a liquid within the container.

The wave source may be disposed on an outer surface of the fluid accommodation portion. Thus, the acoustic wave can be transferred to the liquid via the fluid accommodation portion. The outer surface may define a wall of the fluid accommodation portion, wherein an inner surface of the wall may be in contact with the fluid to be mixed.

The fluid accommodation portion may comprise a solid section and the wave source may be disposed on the solid section to inject at least part of the acoustic wave into the fluid via the solid section. Alternatively, the acoustic wave may travel through the solid section and create an SAW on an inner surface of the solid section. This inner SAW can be refracted into the liquid, when the SAW passes a section of the inner surface which is in contact with a fluid (i.e., a partly filled fluid accommodation portion or the fluid accommodation portion while it is being filled).

The fluid accommodation portion can comprise the inner surface and the fluid may be in contact with the inner surface and the wave source is disposed on an outer surface of the solid section.

The mixing assembly may comprise a second wave source and the fluid accommodation portion may comprise a first sidewall and a second sidewall, which are oriented angled with respect to one another. The wave source may be disposed on the first sidewall and the second wave source may be disposed on the second sidewall, such that the wave sources generate acoustic waves travelling at an angle with respect to one another through the fluid in the fluid accommodation portion. Thereby, turbulence in the fluid flow can be increased. A more turbulent flow leads to more efficient mixing of the fluid. The mixing assembly can comprise a plurality of wave sources configured to generate acoustic waves in the fluid which are angled with respect to one another. Alternatively, a plurality of acoustic waves which enter the fluid at different angles can be created by a single wave source. According to a further preferable embodiment of the invention, a plurality of wave sources can by disposed on a plurality of sidewalls of the fluid accommodation portion. The sidewalls can be angled towards one another so that the acoustic waves are at different angles to one another. With the angled side walls, also the acoustic wave sources can be angled with respect to one another.

The first sidewall and the second sidewall may be oriented perpendicular to one another.

The wave source may form a solid section of the fluid accommodation portion to inject at least part of the acoustic wave into the fluid.

The wave source may be configured to generate a surface acoustic wave travelling on the inner surface of the fluid accommodation portion. In particular, the wave source can be configured to acoustically excite the material which constitutes the fluid accommodation portion.

The fluid accommodation portion may be configured to refract the generated surface acoustic wave into the fluid, when the fluid accommodation portion is filled with the fluid. The fluid accommodation portion can be comprised of an acoustically excitable solid material, i.e. a polymer, metal and/or ceramic compound. Preferably, the fluid accommodation portion can be comprised of a sinter, in particular a metal sinter. The fluid accommodation portion can be formed using 3D printing. Furthermore, the fluid accommodation portion can comprise a coating layer. The coating layer can be disposed at a portion of the fluid accommodation portion where the wave source is disposed. Furthermore, the coating layer can be disposed on a surface in contact with the fluid to be mixed.

The mixing assembly may comprise a piston and the fluid accommodation portion may comprise an opening. The piston may be insertable into the opening to exert a force onto the fluid present in the fluid accommodation portion. The piston can thereby increase the pressure of the fluid and/or push the fluid out of the fluid accommodation portion. The piston can be sealed against the opening to create a fluid-tight volume defined by the piston and the fluid accommodation portion.

The fluid accommodation portion may form a piston chamber of a pump head. In particular, the piston can be fully inserted into the fluid accommodation portion. A fluid volume, i.e. a compression zone to hold the fluid, can remain once the piston is fully inserted. The pump head may pump and/or pressurize a fluid and comprise a piston bore. Furthermore, the pump head may comprise a component configured to oscillate when excited by an acoustic wave. The component can be disposed within the piston bore in direct contact with the fluid to mix the fluid by means of the oscillation. Preferably, the component is an existing component within the pump that serves a further purpose besides being excitable by an ultrasonic wave. In particular, existing components within the pump head can be coupled to the wave source so as to also mix the fluid besides the primary function of the component. The component can be a sidewall of the piston chamber, the piston or any other solid structure in contact with the fluid and part of the pump head.

The fluid accommodation portion may form a high-pressure chamber, configured to withstand pressures exceeding 100 bar, preferably exceeding 500 bar, such as exceeding 100 bar.

The wave source may be fluidly isolated from the fluid contained in the fluid accommodation portion. Thus, the risk of the fluid coming in contact with components carrying electrical signals can be reduced. Additionally, corrosion of the wave source by the liquid can be prevented.

The piston may be configured movable along a compression axis to increase or decrease the volume inside the fluid accommodation portion. The inner surface of the fluid accommodation portion may be shaped in such a way as to be positive form locking with the piston. This can reduce the amount of fluid present between the inner wall and the piston when the piston is inserted into the fluid accommodation portion to compress the fluid.

The inner surface may have a cylindric shape and the opening forms a circular aperture at an end face of the cylindric volume encompassed by the fluid accommodation portion.

The piston may have a cylindric shape and a lateral surface of the piston maintains a constant distance from the inner surface of the fluid accommodation portion, when the piston is inserted into the fluid accommodation. Thus, a predefined of fluid can be present between the lateral surface and the inner surface, when the piston is inserted into the fluid accommodation portion.

The transducer may be configured to generate a fluid flow in a fluid disposed on the transducer or disposed on the solid substrate by refracting the SAW into the fluid. The energy of the SAW can be dissipated into the fluid to create fluid motion, in particular a mixing flow.

The fluid accommodation portion may be removably disposed on the surface of the chip. The fluid accommodation portion can be a probe vial, which is temporarily in contact with the wave source to mix a fluid. The wave source can be modular and thus connected to the fluid accommodation portion when mixing is required. A gap may form between the fluid accommodation portion and the surface of the chip when generating a SAW.

A coupling layer may be disposed between the fluid accommodation portion and the surface of the chip. The coupling layer may be configured to increase the matching of an acoustic impedance of the transducer and a further acoustic impedance of the fluid accommodation portion to acoustically couple the transducer and the fluid accommodation portion. The surface acoustic wave may be refracted into the fluid accommodation portion via the coupling layer. A parameter of interest for transmitting sound waves is the characteristic acoustic impedance, also known as wave resistance. It depends on the density of the medium and the speed of sound. The difference between the sound impedances of two media determines whether and how well the sound waves can be transferred from one medium to another. If this difference is too large, the sound is reflected and transmission may be impeded. The coupling layer between the piezoelectric substrate and the fluid may decrease a difference in sound impedance and therefore increases the transmission quality. Preferably, the thickness of the coupling layer is equal to a quarter of the wavelength (λ/4) of the generated ultrasonic wave.

The coupling substance may be a fluid, which forms a layer between the fluid accommodation portion and the surface of the chip. Preferably, the coupling substance is a liquid (i.e. water, oil, solvent) with low evaporation, respectively a low vapor pressure at operating temperature. Alternatively, the coupling substance can be an elastomer, an epoxide, a resin, or an adhesive material, in particular a glue or an adhesive tape.

The fluid accommodation portion may be configured to refract an acoustic wave transmitted via the coupling substance to the fluid accommodation portion into the fluid accommodated within the fluid accommodation portion. Thus, the fluid accommodation portion is efficiently acoustically coupled to the fluid. The inner surface of the fluid accommodation portion can have a specific surface structure to increase the acoustic coupling.

The fluid accommodation portion may comprise a wall which is defined by the inner surface and an outer surface. The wall can have a specific thickness adjusted to withstand the pressure generated within the fluid accommodation portion. Furthermore, the wall can by monolithic.

The outer surface may form a cuboid or a cylinder. Thus, the geometry of the inner surface can be independent from the geometry of the outer surface. For example, the outer surface may be rectangular, and the inner surface may be a cylinder. Rounded shapes are preferable to accommodate a piston and/or to distribute the pressure of the fluid evenly.

The acoustic wave may comprise an energy and the wall may be configured to configured to couple 1% to 60%, preferably 5% to 20%, such as 10% to 20% the energy of the acoustic wave into the fluid between the inner surface and the piston.

The piezoelectric substrate can be attached to the coupling layer in such a way that the IDT can generate an exposed SAW. An exposed SAW can be an SAW travelling along a surface in contact with air. The SAW can travel toward a contact boundary between the air and a coupling layer. When the SAW passes this boundary, the sound wave can be refracted into the coupling layer and subsequently into the pump head material to continue toward the piston bore where the fluid can be mixed. Transmission losses can be reduced by decreasing the path length of the acoustic wave to the fluid. Therefore, the fluid accommodation portion, i.e., the pump head, can have a reduced thickness at the entry point or entry surface of the acoustic wave. The energy dissipation from the inner surface can be exponential. Furthermore, a SAW generated on the inner surface of the liquid accommodation portion may dissipate the majority of the energy in a fluid layer close to the inner surface.

The mixing assembly may comprise a transmission material which is disposed between the wave source and the wall, wherein the transmission material is configured to transmit at least a part of the wave to the wall. The transmission material can comprise a polymer, silicone, polyurethane, adhesive components, ecological adhesives, honey additives, natural resin and/or artificial resin. The transmission material can provide a layer to couple, seal and/or optimize energy transfer. Generally, a suitable material for the coupling layer can be chosen based on its reflection and transmission properties regarding acoustic waves.

Similar to optical anti-reflective coatings, the coupling layer can be configured to minimize reflections of the acoustic wave traveling from the piezoelectric substrate to the fluid. The coupling layer can minimize the reflection of one or many wavelengths and/or on an interface between two materials by providing an extra material for acoustic wave to interact with. This can reduce the total reflection coefficient of the system by having the acoustic wave reflect from two interfaces where each interface has a smaller difference in refraction indices than the original interface. This type coupling layer can be an antireflection coating. The optimum refractive index of the coupling layer n_{c} to minimize the total reflection coefficient is given by the geometric mean of the refractive indices of the two materials, the piezoelectric substrate n₁ and the fluid accommodation portion n₂ that make up the original interface:

n_{c}=\sqrt{n₁×n₂}

The coupling layer can comprise titanium and/or lithium niobate, to generate a coupling layer with a suitable acoustic impedance. In comparison to a solid coupling layer, a liquid coupling layer can achieve a better acoustic impedance match.

The transmission material may be a transmission liquid. A liquid may achieve a more efficient coupling when the surface of the wave source and the adjacent surface of the wall of the fluid accommodation portion are not form matched, respectively flat, to one another.

The transmission material can comprise a 2-component adhesive, in particular an epoxy-based resin. A 2-component adhesive can also be used as a coupling layer. The adhesive can be configured to attach to the chip and to the pump head simultaneously. Furthermore, the transmission material can comprise polydimethylsiloxane (PDMS). A transmission material comprising PDMS can be fastened to the wave source and/or the fluid accommodation portion. The transmission material can be attached by bonding or soldering. A thin metal foil can be heated to join two bonding surfaces into one piece.

The mixing assembly may comprise a seal, wherein the fluid accommodation portion forms a piston chamber and the seal is disposed circumferential at the opening to seal the piston against the fluid accommodation portion. Thereby, the piston chamber and the piston are sealed and movably connected to one another such that the piston can be inserted into the piston chamber and compress fluid, without fluid spilling through a gap between piston and piston chamber.

The transmission material may have a thickness in the range of 1 μm to 200 μm.

The transmission material may be in contact with the outer surface of the wall. This can achieve an effective acoustic coupling between the piezoelectric substrate respectively the transducer and the fluid accommodation portion.

The liquid chromatography system may comprise a pump and the pump may comprise the fluid accommodation portion.

The pump may comprise a pump head comprising the fluid accommodation portion. In particular, the fluid accommodation portion can constitute a piston chamber of a pump head configured to compress and/or pump fluid by the action of a piston moving into the piston chamber.

The liquid chromatography system may comprise a fluid container for holding a solvent or a sample, and the fluid container comprises the fluid accommodation portion.

The wave source may be located outside of the fluid accommodation portion. In particular, the wave source can be disposed on an outer surface of the fluid accommodation portion which is at atmospheric pressure and not in contact with the fluid. The piezoelectric substrate can be part of a wall, an inset into the wall, or mounted on top of the wall of the fluid accommodation portion. The wall may be an integral part of the fluid accommodation portion, which is acoustically coupled to a volume configured to hold the fluid.

The fluid accommodation portion may be in a high-pressure region of the liquid chromatography system.

The wave source may comprise a volume oscillator. When a volume oscillator is immersed in a viscous fluid, its resonant frequency of natural oscillation and its damping may change as a function of the viscosity and density of the fluid. A volume oscillator can comprise a piezoelectric quartz crystal and may be partly or fully immersed in the fluid.

The wave source may be configured to generate acoustic wave pulses. Pulsing the acoustic wave can reduce the amount of excess heat generated by the wave source, in particular generated by the oscillating piezoelectric substrate. Thus, the amount of heat deposited from the wave source into the fluid can be reduced. The piston can form a topographical obstruction that generates a “sound shadow”. A sound shadow can be an area through which the acoustic waves fail to propagate. In particular, when the piston is in motion it can intermittently generate a sound shadow. Mixing of the fluid can be diminished in the area of the sound shadow.

Thus, the motion of the piston can be coupled to the pulsing of the acoustic wave. In particular, the piston motion and the acoustic wave pulses can be synchronized such that when the piston creates a sound shadow within the liquid, no pulse is propagating through the liquid. Therefore, when mixing is inhibited the heat transfer into the fluid can be minimized. The fluid may thus not experience any further temperature change beyond the pumping process.

The wave source may be configured to generate a frequency-, amplitude- and/or phase-modulated acoustic wave. Thus, the acoustic wave can be customized to increase the energy transfer into the fluid based on the properties of the fluid, e.g., density, viscosity, temperature, pressure, and/or composition. The plurality of forms of modulation can affect the flow patterns and introduce additional disorder. This can increase the mixing and achieve a higher uniformity of the mixture.

The mixing assembly may comprise at least two signal sources, and wherein the wave source is configured to receive a respective excitation signal from each of the at least two signal sources, and wherein the excitation signals have different amplitudes and/or frequencies with respect to one another. Also, the phase of the excitation signal can vary between the wave sources.

The wave source may comprise a transducer having more than one resonant frequency.

The wave source may comprise a tapered transducer which is configured to adjust the location of the sound generation. The tapered transducer can comprise a slanted electrode strand geometry. In particular, the first electrode and the second electrode can form a trapezoid, where the first electrode comprises a base electrode strand that is shorter than a further base electrode strand of the second electrode. With a tapered transducer, the resonance condition may also be spatially defined. Because of the trapezoidal shape, only a part of the transducer is in resonance with the electrical signal. So a wave may be generated only at certain places. By regulating the place of origin, an improved mixing may be achieved.

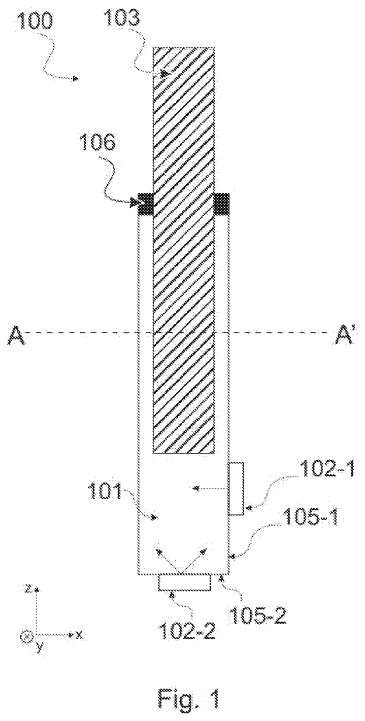

The wave source may comprise a focused transducer, which is configured to increase a sound intensity at a predetermined location. An example of a focused transduced is provided, e.g., Fig. 1 of in Green, “SAW Convolvers Using Focused Interdigital Transducers”, IEEE Transactions on Sonics and Ultrasonics, 1983, 30, p. 43-50. By using a focused transducer, the energy transfer into the liquid can be limited to a predefined area, in particular a predefined area of the inner surface of the liquid accommodation portion. This can create a velocity gradient in the liquid enhancing the mixing. The focused transducer can be configured to focus an acoustic wave. In particular, the focused transducer can be at least partially curved.

The wave source may be configured to receive an excitation signal by capacitive and/or inductive coupling. This type of coupling can replace a metallic, respectively wired, contacting of the wave source. In particular, the wave source can receive an excitation signal wirelessly.

The wave source may comprise a unidirectional transducer and/or a bidirectional transducer. A voltage source connected to the electrode strands drives one half of a set of electrode strands, and its phase-inverted complement drives the other half. The flexural plate waves launched by these sets of transducers add constructively in both directions, giving bidirectional transduction.

To achieve a unidirectional transducer, each electrode strand pair can be spaced one quarter wavelength apart. This strand pair pattern is repeated at wavelength intervals to give a quadrature unidirectional interdigitated transducer. One set of electrode strands is driven by a signal, and the other set of electrode strands is driven by a signal which is 90 degrees out of phase with the first. Now, the flexural plate waves that are generated add constructively in one direction while combining destructively in the other. In this way, unidirectional transduction is achieved.

The wave source may comprise a bidirectional transducer having a mirror, wherein the mirror is configured to reflect at least part of the sound wave generated by the bidirectional transducer to increase the power radiated in the direction of the fluid.

The wave source may comprise a bidirectional transducer and a receiver module, wherein the receiver module is configured as a mirror or reflector to control the sound intensity of a sound wave generated by the bidirectional transducer. According to a further embodiment of the invention, a transmitting IDT can be configured to generate an AW and at least one further receiving IDT can be configured to receive said AW. Preferably, a plurality of receiving IDTs is provided. The receiver IDTs can themselves be configured as AW sources and/or each receiver IDT can be electrically connected to further IDTs, which in turn can be configured to generate an AW, i.e., function as an AW source, These AWs can be used for mixing the fluid. In the process, a frequency transformation can also be made. A single transmitting IDT can therefore act as a source for a plurality of wave sources, each generating an acoustic wave based on the initial acoustic wave received from the transmitting IDT. Thus, many sources can be made from one AW.

The wave source may be configured to receive an excitation signal pulse comprising the resonant frequencies of the wave source.

The wave source may be configured to receive a plurality of pure frequency signals, in particular a Fourier series of signals, which form an effective excitation signal in the form of a square- or sawtooth function.

The wave source may be disposed within the fluid having direct contact with the fluid accommodated within the fluid accommodation portion.

The wave source may comprise a protective layer configured to seal the remainder of the wave source from direct contact with the fluid. The protective layer can be fluid tight. Preferably, the protective layer is insoluble to the fluid present in the fluid accommodation portion. Furthermore, the protective layer may have reduced particle emissions so as to not contaminate the fluid.

The chip may be at least partially in contact with the fluid.

A first surface of the chip, in particular a front face, may be in contact with the fluid and the transducer may be disposed at a further surface of the chip, in particular a back face, wherein the chip may be configured to protect the transducer from contact with the fluid. Thereby, the transducer can be shielded from aggressive fluids.

Each wave source may be configured to generate an acoustic wave, and the wave sources may be configured to generate the acoustic waves simultaneously or at different times with respect to one another to generate a flow in the fluid.

The mixing assembly may comprise two wave sources which are disposed on a single piezoelectric substrate having the form of a chip. The two wave sources may be active simultaneously, alternating or at different time periods which may overlap to generate a fluid flow. A plurality of wave sources can be disposed on a single piezoelectric substrate.

The wave source may be configured to generate a pure mode or a mixed mode as a solid-state sound wave.

The wave source may comprise at least two different ultra sound generation devices which are configured to jointly generate a sound wave. Thereby, the energy input via the acoustic waves into the liquid can be increased, resulting in higher fluid velocities and increased mixing efficiency.

The wave source may comprise a transducer and a volume oscillator to generate ultra sound waves in a HPLC-system. Generally, the wave source can comprise alternative sound generators which are based on different sound generation principles.

The mixing assembly can be disposed at a section of the HPLC-system which is at atmospheric pressure or at further section of the HPLC-system which is at a high pressure. The mixing assembly can comprise a seal which seals an inner volume from the outer atmosphere. Depending on the pressure, the seal can be a high-pressure seal.

The mixing assembly may comprise a plurality of wave sources, wherein the fluid accommodation portion comprises a plurality of enclosed volumes, and wherein a dedicated wave source is used to generate an acoustic wave in each enclosed volume.

Preferably, different sound sources are used at different closed volumes of the HPLC system. The wave source can be disposed in the chromatography fluidics on the atmospheric pressure side and mixes there. Preferably, the wave source is disposed within the chromatography system at atmospheric pressure in the autosampler or fraction collector where it mixes sample vials. Volumes of fluids are mixed that are disposed in closed volumes, but there may be a layer of gas above the liquids so that a free liquid surface forms. This surface is deformable by sound and the deformation can excite an internal flow.

Pertaining to mixing in the autosampler, a robust mechanism may be implemented to support a wiggling motion. Furthermore, mixing due to the wiggling motion can be performed for all samples at once and simultaneously. Thus, the mixing may not be adjustable to the requirements of the individual sample. The wiggling motion can increase mechanical stresses and introduce unwanted vibrations into other components.

The wave source may be configured to pass on a signal with the excitation frequency acting as a transceiver to excite further wave sources. An acoustic wave traveling between two wave sources can be transmitted by a first wave source of the two wave sources and received by a second wave source of the two wave sources. The wave sources can be disposed spaced apart from one another on the same piezoelectric substrate.

The wave source may be configured to couple directly to a liquid layer, wherein the liquid layer is configured to adjust the acoustic impedance. The wave source may couple directly to the fluid to match the acoustic impedance, rather than generating a solid-state sound wave that travels away from the wave source and propagates to the fluid layer. The acoustic wave can then be directly refracted into the liquid and the acoustic energy converted into kinetic energy of the fluid, thus creating a flow.

The mixing assembly may comprise a control module configured to measure a travel-time and/or a phase of an acoustic wave and to determine a pressure within the fluid, a viscosity of the fluid and/or a density of the fluid based on the travel time and/or phase of the acoustic wave.

The mixing assembly may comprise a control module configured to measure a travel-time and/or a phase of an acoustic wave and to determine a temperature of the fluid based on the travel-time and/or phase of the acoustic wave.

The mixing assembly may comprise a control module configured to perform a transmission measurement and/or a phase measurement of an acoustic wave and to determine a conductivity within the fluid based on the transmission measurement and/or the phase measurement of the acoustic wave.

One of the wave sources may be configured as a receiver. Thus, the wave source can measure incoming acoustic waves.

One of the wave sources may be configured to receive an acoustic wave and to simultaneously transmit an acoustic wave. Thereby, feedback regarding the acoustic waves travelling through the fluid accommodation portion and/or the fluid can be captured.

The mixing assembly may comprise a mass coating measurement device, configured to determine a mass coating on a surface. The chip can be used in combination with the mass coating measurement device, especially if a surface of the fluid accommodation portion and/or the wave source is chemically functionalized for this purpose.

An inner surface of the fluid accommodation portion may be chemically functionalized to facilitate a mass coating measurement at the inner surface.

The wave source may be mounted movably to define and control the sound propagation direction and thereby the flow direction in the fluid.

The transmission material may comprise a liquid forming a liquid layer which is configured to multiply reflect an acoustic wave of the wave source at least partially. Thereby, the wave source can be virtualized. Preferably, the reflections of the acoustic wave can be controlled in such a way that the wave source can be virtually multiplied. The liquid layer can have an adequately low thickness suitable for reflection of the acoustic wave to facilitate virtualization of the wave source. Preferably, the transmission material can have a thickness in the range of 0.05 mm to 1 mm. A layer thickness in this range can increase the absorption of the acoustic wave into the material.

Furthermore, a repeated reflection of the acoustic wave at the interfaces such that the acoustic wave travels within the transmission material can be achieved with a suitable layer thickness. Achieving a repeated reflection can depend on the acoustic impedances at the interfaces of adjacent materials. For the transmission material a mismatch of acoustic impedances can be beneficial to increase the reflection of the acoustic wave within the transmission material.

The fluid accommodation portion may have the form of a sample flask and is removably placeable onto the wave source. Thus, the mixing assembly can serve as a base station to mix fluids contained in sample flasks, by placing the flasks onto the transducer. Preferably, acoustic coupling is increased by providing a coupling material, respectively a coupling fluid between the contact faces of the wave source and the sample flask.

The fluid disposed in the fluid accommodation portion may be mixed, and the wave source may be configured to shake the fluid in addition to the fluid being mixed. Shaking the liquid and mixing via ultrasonic excitation can mix the fluid at different scales. Mixing via shaking can mix the fluid on a larger scale, wherein mixing via ultrasonic excitation can mix the fluid on a smaller scale.

The wave source may comprise a volume oscillator, and the volume oscillator may comprise a plurality of stacked volume oscillator modules. A stacked volume oscillator may comprise a plurality of individual piezoelectric layers connected mechanically in series and electrically in parallel to reduce the fundamental thickness mode resonance to a frequency corresponding to the transit time of the complete stack and the electrical impedance to a value which corresponds to that of the layers of the stack in parallel. This may allow lower frequency resonant operation than would be possible with a single layer, and may facilitate electrical impedance matching to the transmission circuitry. On transmission, an ideal stack of uniform layers will have an output amplitude larger than that of the equivalent single layer.

The piezoelectric substrate may be directly processed onto the fluid accommodation portion. Thus, the formation of an air gap may be suppressed and the assembly can be formed in a simple manner.

The piston may be configured to be excited by the sound wave to mix the fluid within the fluid accommodation portion.

A component of the pump head may be excitable to oscillate by the acoustic wave generated by the wave source. Thus, no additional component is required to implement ultrasonic mixing within the pump head. In particular, the wave source can be coupled to an existing pump head so that the fluid bearing volumes and/or tubes can remain intact and/or do not require to be opened.

The fluid accommodation portion may comprise an inner surface having an arbitrary shape and the inner surface may define a mixing volume.

The inner surface may be at least partially in contact with the fluid when mixing the fluid.

The mixing assembly may comprise inner defining structures, which further define the mixing volume. This inner defining structures can guide and/or restrict the flow to increase mixing efficiency. The inner defining structures can be configured to generate a turbulent flow or laminar mixing within the fluid.

The inner defining structure may comprise one of or a plurality of the following shapes: cylinder, cuboid, pyramid, sphere, pore, cone, wherein the inner defining structure is configured to redirect the flow of the fluid to different paths.

The piezoelectric substrate may be directly processed onto the fluid accommodation portion. Thereby, the advantage can be achieved that the formation of a gap, in particular an air gap between the piezoelectric substrate and the wall of the fluid accommodation portion can be avoided. This increases the efficiency of the energy transfer of the acoustic wave from the wave source into the fluid within the fluid accommodation portion. In particular, when the piezoelectric substrate is directly processed onto the fluid accommodation portion a coupling layer may be obsolete. The piezoelectric substrate can be directly processed onto the fluid accommodation portion by welding, gluing, pressing, soldering, crimping, bonding and/or material deposition. Material deposition can comprise direct material deposition, i.e. 3D printing. A mismatch of acoustic impedances between the fluid accommodation portion and the wave source can be reduced or avoided as the fluid accommodation portion and the wave source then form a unitarily excitable acoustic body.

The generation of the sound wave may be done with a volume transducer (e.g. the PRYY+0333 from PIC255 of PI Piezo Technology) or with transducer which generates surface waves.

The sound wave may be generated continuously or pulsed.

The sound wave may be generated by frequency or amplitude or phase modulation or any combination of the 3 modulations.

The sound transducer (transducer or volume transducer) may receive one excitation signal, or several excitation signals, which may be different amplitude and/or frequency.

A transducer or transducer with more than one resonant frequency may be used.

A so-called tapered transducer may be used to change the location of the sound conversion.

A focusing transducer or sonic transducer may be used, e.g., to achieve high sound intensity at a specific location.

The transducer may be contacted metallically, or by radio transmission, in particular by capacitive or inductive coupling.

A bidirectional or unidirectional transducer may be used to generate the sound, wherein it should be understood that the term sound may be used interchangeably with acoustic wave.

A bidirectional transducer with mirror may be used to radiate more power towards the fluidics.

A bidirectional transducer may be used with a receiver element that can be used as a mirror or reflector to control the intensity.

Either, a pure electrical signal may be used to generate the sound, or a signal pulse that includes the resonant frequencies.

The sound source may be fed with several pure frequencies to generate not only a sinusoidal signal, but according to the known Fourier series, a signal similar to a square or sawtooth function.

The sound source may be located separately from the liquid, or in the liquid, where it has direct contact with the liquid.

The sound source may be separate from the liquid, or in the liquid, where it has direct contact with the liquid. In the latter case, the sound source may have a protective layer.

The chip may be in the liquid, and the sound source may be on the back of the chip, so the chip substrate protects the transducer from the possibly aggressive liquid.

More than one sound source may be used, whether simultaneously or at different times.

More than one sound source may be used on a chip, whether simultaneously or at different times.

If more than one sound source is used, they may produce sound simultaneously or alternately to generate flow.

The sound source may generate a pure mode or a mixed mode as a solid-state sound wave.

Different generation methods for ultrasound may be used in combination, e.g. a transducer and a volume transducer in the HPLC system.

Different sound sources may be used at different closed volumes of the HPLC system.

The sound source may be located in the chromatography fluidics on the atmospheric pressure side, where it mixes.

The sonic source may be located within the chromatography system at atmospheric pressure in the autosampler or fraction collector where it mixes sample vials.

Volumes of liquids may be mixed that are in closed volumes, but there is gas above the liquids so that there is a free liquid surface. This surface can be deformed by sound and the deformation can excite an internal flow.

The sound source may cause a transmission of the excitation frequency according to the transmitter-receiver principle, so that further sound sources can be excited.

The sound source may also couple directly to the fluid layer, which is intended to match the acoustic impedance, rather than generating a solid-state sound wave that travels away from the source and propagates to the fluid layer.

There may be more than one sound source on the chip.

On a chip with at least two sound sources, the same chip may be used to utilize the pressure in the fluidics by time-of-flight measurement or phase measurement.

On a chip with at least two sound sources, the same chip may be used to measure the temperature in the pump head by time-of-flight measurement or phase measurement.

On a chip with at least two sound sources, the same chip may be used to measure the conductivity in the liquid by transmission measurement or phase measurement.

On a chip with at least two sound sources, the same chip may be used to measure density by time-of-flight measurement or phase measurement.

On a chip with at least two sound sources, the same chip may be used to measure viscosity by time-of-flight measurement or phase measurement.

At least one of the sound sources on the chip may be used as a receiver.

The sound source may also be used as a receiver for the sound.

The chip may be used in combination with a mass coating measurement, especially if surface is chemically functionalized for this purpose.

The sound source may be movably mounted so that the sound propagation direction and thus the flow direction can be defined and controlled.

The liquid layer between the sound source and the solid may be made so thin that partial multiple reflection of the sound source occurs, so that the sound source is virtualized multiplied.

The sample vial may be placed on the transducer instead, or the transducer may be attached to the vial.

In addition to mixing, the sample vials may also be shaken with ultrasound.

One or more of the intermixed volumes may be flowing at all times or only intermittently.

If the sound source is a volume transducer, it can also be made up of several stacked individual volume transducers

The piezoelectric substrate of the sound source may be processed directly onto the container of the liquid, so that an air gap formation is suppressed and the layer for matching the acoustic impedances can be dispensed with.

The sound wave may excite a component of the pump head to vibrate, wherein the component is inside the piston bore in direct contact with the liquid and, the mechanical deflection of this component may mix the liquid by its vibration.

The component may be firmly connected to the head or is already a part of the pump head due to its manufacture.

The sound wave may excite a free-moving component in the piston bore to move translationally or periodically, so that this movement results in mixing.

The sound wave may excite an existing component in the pump head to vibrate, e.g. the piston, which then mixes in the pump head.

A component with piezoelectric properties may be installed inside the piston bore and may cause a flow in the piston bore through vibrations, which is used for mixing.

The present technology may also be used in an additional volume located in the piston bore where the stroke of the piston does not reach, or may be located in the pump head separated from the piston bore or located outside the pump head as an independent component.

The mixing may take place in a volume that does not have a cylindrical geometry, but a boundary of any shape.

The mixing may take place in a volume that also has internal limiting structures, such as a plugged cylinder or pores, which may ensure that the liquid takes different paths on the way past or through it.

Mixing may also take place in a volume that is separated from an unmixed portion of the total flow, and the two or more partial flows may be recombined to form a total flow of the same size.

According to a further aspect the invention relates to a liquid chromatography system comprising a mixing assembly. The system may be a high-performance liquid chromatography system, in particular, an ion chromatography system.

The system may comprise a pump head configured to pump and/or pressurize a fluid. The pump head can be a solid body, preferably a metal body, in which one or multiple cylinders or chambers are milled or drilled to accommodate the piston(s). These chambers can form piston bores. A piston can be a rod made of inert materials like sapphire, ceramics, steel, or alloy. The piston can be reciprocating within a piston bore in the pump head. The pump head can be part of a pump configured to pump a fluid, in particular a liquid, through the system. For its use in chromatography the pump can realize a uniform mixture of the fluid. The function of the mixing assembly can be to convert two or more liquid streams into a uniform mixture so that concentration variations of the individual components do not affect analysis and detection.

The system may comprise a plurality of enclosed volumes, wherein a wave source is disposed at each enclosed volume to generate an acoustic wave in the respective enclosed volume. Thus, fluid in each pump head can be mixed independently.

The system may comprise a pressured section and a further section at atmospheric pressure, wherein the wave source is disposed in the section at atmospheric pressure. The pressured section can comprise a fluid at a higher pressure compared to a surrounding atmospheric pressure. Preferably, the pressured section is sealed against the surrounding atmosphere.

The system may comprise a sampler and the wave source can be disposed at the sampler at atmospheric pressure to mix a liquid contained within a sample flask disposed in the sampler.

The system may comprise a fraction collector and the wave source can be disposed at the fraction collector at atmospheric pressure to mix a liquid contained within a sample flask disposed in the fraction collector. The fraction collector can be configured to collect separations of mixtures through the process of fractionation.

The enclosed volumes may be partially filled with liquid and partially filled with a gas in such a manner that a free fluid surface forms between the liquid and the gas, wherein the free fluid surface is deformable by sound and a deformation by sound causes an internal flow. Thus, an AW can be coupled into the liquid via the liquid-gas-interface to mix the liquid.

The volumes may be configured to contain liquid continuously at any time or are flowed through intermittently.

The pump head may comprise a component configured to be excitable to oscillate by the acoustic wave generated by the wave source. Thereby, the coupling of the AW into the fluid can enhanced. Increasing an acoustic coupling between the wave source and the fluid to be mixed can be defined as maximizing the energy transfer from the wave source to the fluid via the AW. Hence, energy losses of the acoustic wave caused by reflection, diffraction attenuation and/or dissipation can be minimized.

The pump head may comprise a piston bore and the component is disposed within the piston bore in direct contact with the fluid to mix the fluid by means of the oscillation.

The component may be disposed freely movable within the piston bore and configured to move translationally and/or periodically, wherein the movement of the component mixes the fluid.

The component may be an existing component within the pump head such that no additional fluid volume is introduced into the system. In particular, the component can be a piston or a part of the piston bore. The component can be formed or bonded integrally with the pump head.

The component can be piezoelectric and configured to generate a flow inside the piston bore by oscillating, which is used for mixing.

The system may comprise an additional volume, which is disposed in or adjacent and connected to the piston bore, wherein a stroke of a piston into the piston bore does not reach into the additional volume and wherein the fluid is mixed within the additional volume. The range of motion of the piston can be restricted, so that the additional volume has a predetermined size and may be always or at least during operation filled with fluid.

An additional volume may be disposed in the pump head and the additional volume may be separate from the piston bore, wherein the fluid is mixed in the additional volume.

The additional volume may still be part of or integrated into the piston head.

The system may comprise a mixing volume which is disposed outside of the pump head and/or forms a separate component of the liquid chromatography system.

The system may comprise a piston and the fluid accommodation portion may comprise an opening, wherein the piston is insertable into the opening to exert a pressure onto the fluid present in the fluid accommodation portion. The fluid accommodation portion may form a piston chamber, in particular a piston bore, of the pump head.

The liquid chromatography system may comprise a pump which may comprise the fluid accommodation portion. Furthermore, the pump may comprise a pump head and which may comprise the fluid accommodation portion.

The system may comprise two wave sources disposed on a single piezoelectric substrate having the form of a chip and may comprise a control module configured to measure a travel-time and/or a phase of an acoustic wave generated by at least one of the wave sources and to determine a temperature within the pump head based on the travel-time and/or phase of the acoustic wave.

The system may comprise at least one additional volume configured for mixing at least a partial flow of the fluid by the mixing assembly, wherein the additional volume is disposed separate from an unmixed partial flow of the total flow, and wherein the at least two partial flows form a total flow of the same size.

The system may comprise a fluid container for holding a solvent or a sample, wherein the fluid container comprises the fluid accommodation portion. The system may comprise a high-pressure region forming the fluid accommodation portion.

According to a further aspect the invention relates to a method of mixing a liquid, wherein the method comprises
providing a mixing assembly or a liquid chromatography system,
providing a liquid into the liquid accommodation portion,
the wave source generating an acoustic wave,
injecting at least a part of the acoustic wave into the liquid accommodated in the liquid accommodation portion and thereby mixing the liquid in the liquid accommodation portion.

Generating an acoustic wave may comprise generating a single mode and/or single frequency ultra-sonic wave. This can achieve the advantage of generating a standing wave. Furthermore, the material properties of the mixing assembly can be optimized to maximize wave propagation from the wave source to the fluid. Preferably, the acoustic impedances of the materials can be adjusted based on the single mode and/or single frequency of the AW.

Generating an acoustic wave may comprise generating an ultrasonic wave composed of a plurality of resonant frequencies of the wave source. In particular, the AW can comprise harmonics of a single base frequency or a plurality of base frequencies. The plurality of base frequencies can be determined by the electrically conducting structure, the geometry of the piezoelectric substrate and/or the properties of the IDT in general.

Injecting the acoustic wave into the liquid comprises refracting an acoustic wave at least partially from the wave source into the liquid accommodation portion and subsequently refracting the acoustic wave at least partially from the liquid accommodation portion into the liquid. Refracting the acoustic wave from the wave source into the liquid accommodation portion may comprise refracting the acoustic wave from the wave source into a coupling layer and refracting the acoustic wave from the coupling layer into the liquid accommodation portion.

The method may comprise, compressing and/or pressurizing the fluid disposed in the fluid accommodation portion. In particular, the fluid can be compressed and/or pumped by a piston moving into the piston bore.

The mixing assembly may be configured to perform the method.

The liquid chromatography system may be configured to perform the method. The invention is further described with the following numbered embodiments.

Below, assembly embodiments will be discussed. These embodiments are abbreviated by the letter “A” followed by a number. Whenever reference is herein made to “assembly embodiments”, these embodiments are meant.

A1. A mixing assembly for mixing a fluid, wherein the mixing assembly comprises
a fluid accommodation portion configured to accommodate the fluid,
a wave source, wherein the wave source is configured to generate an acoustic wave,
wherein the mixing assembly is configured to inject at least part of the acoustic wave into the fluid accommodated in the fluid accommodation portion to thereby cause mixing of the fluid in the fluid accommodation portion.
   A2. The mixing assembly according to the preceding embodiment, wherein the wave source is configured to generate the acoustic wave with a frequency in the range of 1 MHz to 1 GHz.
   A3. The mixing assembly according to any of the preceding embodiments, wherein the wave source is configured to generate the acoustic wave with a power in the range of 10 μW to 10 W.
   A4. The mixing assembly according to any of the preceding embodiments, wherein the fluid is a liquid, and wherein the mixing assembly is configured for mixing the liquid in a liquid chromatography system, preferably a high-performance liquid chromatography system or an ion chromatography system.
   A5. The mixing assembly according to any of the preceding embodiments, wherein the wave source comprises a transducer configured to convert an electrical signal into an acoustic wave, in particular an ultrasonic wave.
   A6. The mixing assembly according to any of the preceding embodiments wherein the wave source comprises a piezoelectric substrate.
   A7. The mixing assembly according to any of the preceding embodiments with the features of embodiments A5, wherein the piezoelectric substrate has the form of a chip.
   A8. The mixing assembly according to any of the preceding embodiments with the features of embodiment A5, wherein the transducer comprises an electrically conducting structure which is disposed on the piezoelectric substrate.
   A9. The mixing assembly according to any of the preceding embodiments with the features of embodiment A8, wherein the electrically conducting structure is a metallic structure.
   A10. The mixing assembly according to any of the preceding embodiments with the features of embodiment A8, wherein the electrically conducting structure is configured to receive an electrical signal.
   A11. The mixing assembly according to any of the preceding embodiments with the features of embodiment A8, wherein the electrically conducting structure comprises two electrodes, wherein each electrode comprises a plurality of electrode strands and wherein the electrode strands are disposed in an alternating pattern parallel and spaced to each other, to limit the transducer to the excitation of a single resonance frequency.
   A12. The mixing assembly according to any of the preceding embodiments with the features of embodiment A10, wherein the transducer is configured to induce a mechanical displacement of the piezoelectric substrate based on the received electrical signal.
   A13. The mixing assembly according to any of the preceding embodiments with the features of embodiment A12, wherein the transducer has at least one resonant vibration mode which is excitable by the electrical signal and wherein the transducer is configured to generate a sound wave when the transducer is excited resonantly on the basis of the electrical signal.
   A14. The mixing assembly according to any of the preceding embodiments with the features of embodiment A7 and A13, wherein the transducer is configured to generate an acoustic wave (AW), in particular a surface acoustic wave (SAW), which travels along a surface of the chip or a shear wave (SH-SAW) which travels along the surface of the chip and/or through the volume of the chip.
   A15. The mixing assembly according to any of the preceding embodiments with the features of embodiment A14, comprising a solid substrate, wherein the transducer is acoustically coupled to the solid substrate to generate a SAW on a surface of the solid substrate.
   A16. The mixing assembly according to any of the preceding embodiments with the features of embodiment A14, wherein the chip is configured to decouple and/or refract the acoustic wave from the surface when physical boundary conditions at the surface change, in particular when the medium disposed on the surface changes.
   A17. The mixing assembly according to any of the preceding embodiments, wherein the fluid accommodation portion is configured as a fluid-tight container having at least one opening.
   A18. The mixing assembly according to any of the preceding embodiments with the features of embodiment A17, wherein the wave source is disposed on an outer surface of the fluid accommodation portion.
   A19. The mixing assembly according to any of the preceding embodiments with the features of embodiment A17, wherein the fluid accommodation portion comprises a solid section and wherein the wave source is disposed on the solid section to inject at least part of the acoustic wave into the fluid via the solid section.
   A20. The mixing assembly according to any of the preceding embodiments with the features of embodiment A19, wherein the fluid accommodation portion comprises an inner surface, and wherein the fluid is in contact with the inner surface and the wave source is disposed on an outer surface of the solid section.
   A21. The mixing assembly according to any of the preceding embodiments with the features of embodiment A17, comprising a second wave source, wherein the fluid accommodation portion comprises a first sidewall and a second sidewall, which are oriented angled with respect to one another, wherein the wave source is disposed on the first sidewall and the second wave source is disposed on the second sidewall, such that the wave sources generate acoustic waves travelling at an angle with respect to one another through the fluid in the fluid accommodation portion.
   A22. The mixing assembly according to any of the preceding embodiments with the features of embodiment A21, wherein the first sidewall and the second sidewall are oriented perpendicular to one another.
   A23. The mixing assembly according to any of the preceding embodiments with the features of embodiment A17, wherein the wave source forms a solid section of the fluid accommodation portion to inject at least part of the acoustic wave into the fluid.
   A24. The mixing assembly according to any of the preceding embodiments with the features of embodiment A20, wherein the wave source is configured to generate a surface acoustic wave travelling on the inner surface of the fluid accommodation portion.
   A25. The mixing assembly according to any of the preceding embodiments with the features of embodiment A24, wherein the fluid accommodation portion is configured to refract the generated surface acoustic wave into the fluid, when the fluid accommodation portion is filled with the fluid.
   A26. The mixing assembly according to any of the preceding embodiments, comprising a piston and wherein the fluid accommodation portion comprises an opening, and wherein the piston is insertable into the opening to exert a force onto the fluid present in the fluid accommodation portion.
   A27. The mixing assembly according to any of the preceding embodiments, wherein the fluid accommodation portion forms a piston chamber of a pump head.
   A28. The mixing assembly according to any of the preceding embodiments, wherein the fluid accommodation portion forms a high-pressure chamber, configured to withstand pressures exceeding 100 bar, preferably exceeding 500 bar, such as exceeding 1000 bar.
   A29. The mixing assembly according to any of the preceding embodiments, wherein the wave source is fluidly isolated from the fluid contained in the fluid accommodation portion.
   A30. The mixing assembly according to any of the preceding embodiments with the features of embodiment A26, wherein the piston is configured movable along a compression axis to increase or decrease the volume inside the fluid accommodation portion.
   A31. The mixing assembly according to any of the preceding embodiments with the features of embodiment A20, wherein the inner surface has a cylindric shape, and wherein the opening forms a circular aperture at an end face of the cylindric volume encompassed by the fluid accommodation portion.
   A32. The mixing assembly according to any of the preceding embodiments with the features of embodiment A26 and A31, wherein the piston has a cylindric shape and wherein a lateral surface of the piston maintains a constant distance from the inner surface of the fluid accommodation portion, when the piston is inserted into the fluid accommodation
   A33. The mixing assembly according to any of the preceding embodiments with the features of embodiment A15 or A16, wherein the transducer is configured to generate a fluid flow in a fluid disposed on the transducer or disposed on the solid substrate by refracting the SAW into the fluid.
   A34. The mixing assembly according to any of the preceding embodiments with the features of embodiment A14, wherein the fluid accommodation portion is removably disposed on the surface of the chip.
   A35. The mixing assembly according to any of the preceding embodiments with the features of embodiment A34, wherein a coupling layer is disposed between the fluid accommodation portion and the surface of the chip, and wherein the coupling layer is configured to increase the matching of an acoustic impedance of the transducer and a further acoustic impedance of the fluid accommodation portion to acoustically couple the transducer and the fluid accommodation portion, and wherein the surface acoustic wave is refracted into the fluid accommodation portion via the coupling layer.
   A36. The mixing assembly according to any of the preceding embodiments with the features of embodiment A35, wherein the coupling substance is a fluid and/or an adhesive, in particular an elastomer, an epoxide, a resin, a glue and/or an adhesive tape, which forms a layer between the fluid accommodation portion and the surface of the chip.
   A37. The mixing assembly according to any of the preceding embodiments with the features of embodiment A35, wherein the fluid accommodation portion is configured to refract an acoustic wave transmitted via the coupling substance to the fluid accommodation portion into the fluid accommodated within the fluid accommodation portion.
   A38. The mixing assembly according to any of the preceding embodiments with the features of embodiment A20, wherein the fluid accommodation portion comprises a wall which is defined by the inner surface and an outer surface.
   A39. The mixing assembly according to any of the preceding embodiments with the features of embodiment A38, wherein the outer surface forms a cuboid or a cylinder.
   A40. The mixing assembly according to any of the preceding embodiments with the features of embodiments A26 and A38, wherein the acoustic wave comprises an energy, and wherein the wall is configured to couple 1% to 60%, preferably 5% to 20%, such as 10% to 20% the energy of the acoustic wave into the fluid between the inner surface and the piston.
   A41. The mixing assembly according to any of the preceding embodiments with the features of embodiment A38, wherein the mixing assembly comprises a transmission material which is disposed between the wave source and the wall, wherein the transmission material is configured to transmit at least a part of the wave to the wall.
   A42. The mixing assembly according to the preceding embodiment with the features of embodiment A41, wherein the transmission material is a transmission liquid.
   A43. The mixing assembly according to the preceding embodiment with the features of embodiment A26, comprising a seal, wherein the fluid accommodation portion forms a piston chamber and wherein the seal is disposed circumferential at the opening to seal the piston against the fluid accommodation portion.
   A44. The mixing assembly according to any of the preceding embodiments with the features of embodiment A41, wherein the transmission material has a thickness in the range of 1 μm to 200 μm.
   A45. The mixing assembly according to any of the preceding embodiment with the features of embodiment A41, wherein the transmission material is in contact with the outer surface of the wall.
   A46. The mixing assembly according to any of the preceding embodiments with the features of A4, wherein the liquid chromatography system comprises a pump and wherein the pump comprises the fluid accommodation portion.
   A47. The mixing assembly according to the preceding embodiment, wherein the pump comprises a pump head and wherein the pump head comprises the fluid accommodation portion.
   A48. The mixing assembly according to any of the preceding embodiments with the features of A4, wherein the liquid chromatography system comprises a fluid container for holding a solvent or a sample, and wherein the fluid container comprises the fluid accommodation portion.
   A49. The mixing assembly according to any of the preceding embodiments, wherein the wave source is located outside of the fluid accommodation portion.
   A50. The mixing assembly according to any of the preceding embodiments with the features of A4, wherein the fluid accommodation portion is in a high-pressure region of the liquid chromatography system.
   A51. The mixing assembly according to any of the preceding embodiments, wherein the wave source comprises a volume oscillator.
   A52. The mixing assembly according to any of the preceding embodiments, wherein the wave source is configured to generate acoustic wave pulses.
   A53. The mixing assembly according to any of the preceding embodiments, wherein the wave source is configured to generate a frequency-, amplitude- and/or phase-modulated acoustic wave.
   A54. The mixing assembly according to any of the preceding embodiments, comprising at least two signal sources, and wherein the wave source is configured to receive a respective excitation signal from each of the at least two signal sources, and wherein the excitation signals have different amplitudes and/or frequencies with respect to one another.
   A55. The mixing assembly according to any of the preceding embodiments, wherein the wave source comprises a transducer having more than one resonant frequency.
   A56. The mixing assembly according to any of the preceding embodiments, wherein the wave source comprises a tapered transducer which is configured to adjust the location of the sound generation.
   A57. The mixing assembly according to any of the preceding embodiments, wherein the wave source comprises a focused transducer, which is configured to increase a sound intensity at a predetermined location.
   A58. The mixing assembly according to any of the preceding embodiments, wherein the wave source is configured to receive an excitation signal by capacitive and/or inductive coupling.
   A59. The mixing assembly according to any of the preceding embodiments, wherein the wave source comprises a unidirectional transducer and/or a bidirectional transducer.
   A60. The mixing assembly according to any of the preceding embodiments, wherein the wave source comprises a bidirectional transducer having a mirror, wherein the mirror is configured to reflect at least part of the sound wave generated by the bidirectional transducer to increase the power radiated in the direction of the fluid.
   A61. The mixing assembly according to any of the preceding embodiments, wherein the wave source comprises a bidirectional transducer and a receiver module, wherein the receiver module is configured as a mirror or reflector to control the sound intensity of a sound wave generated by the bidirectional transducer.
   A62. The mixing assembly according to any of the preceding embodiments, wherein the wave source is configured to receive an excitation signal pulse comprising the resonant frequencies of the wave source.
   A63. The mixing assembly according to any of the preceding embodiments, wherein the wave source is configured to receive a plurality of pure frequency signals, in particular a Fourier series of signals, which form an effective excitation signal in the form of a square- or sawtooth function.
   A64. The mixing assembly according to any of the preceding embodiments, wherein the wave source is disposed within the fluid having direct contact with the fluid accommodated within the fluid accommodation portion.
   A65. The mixing assembly according to any of the preceding embodiments with the features of embodiment A65, wherein the wave source comprises a protective layer configured to seal the remainder of the wave source from direct contact with the fluid.
   A66. The mixing assembly according to any of the preceding embodiments with the features of embodiment A7, wherein the chip is at least partially in contact with the fluid.
   A67. The mixing assembly according to any of the preceding embodiments with the features of embodiment A7, wherein a first surface of the chip, in particular a front face, is in contact with the fluid and the transducer is disposed at a further surface of the chip, in particular a back face, wherein the chip is configured to protect the transducer from contact with the fluid.
   A68. The mixing assembly according to any of the preceding embodiments, comprising at least two wave sources, wherein each wave source is configured to generate an acoustic wave, and wherein the wave sources are configured to generate the acoustic waves simultaneously or at different times with respect to one another to generate a flow in the fluid.
   A69. The mixing assembly according to any of the preceding embodiments with the features of embodiment A68, comprising two wave sources which are disposed on a single piezoelectric substrate having the form of a chip.
   A70. The mixing assembly according to any of the preceding embodiments, wherein the wave source is configured to generate a pure mode or a mixed mode as a solid-state sound wave.
   A71. The mixing assembly according to any of the preceding embodiments, wherein the wave source comprises at least two different ultra sound generation devices which are configured to jointly generate a sound wave.
   A72. The mixing assembly according to any of the preceding embodiments with the features of embodiment A71, wherein the wave source comprises a transducer and a volume oscillator to generate ultra sound waves in a HPLC-system.
   A73. The mixing assembly according to any of the preceding embodiments, comprising a plurality of wave sources, wherein the fluid accommodation portion comprises a plurality of enclosed volumes, and wherein a dedicated wave source is used to generate an acoustic wave in each enclosed volume.
   A74. The mixing assembly according to any of the preceding embodiments, wherein the wave source is configured to pass on a signal with the excitation frequency acting as a transceiver to excite further wave sources.
   A75. The mixing assembly according to any of the preceding embodiments, wherein the wave source is configured to couple directly to a liquid layer, wherein the liquid layer is configured to adjust the acoustic impedance.
   A76. The mixing assembly according to any of the preceding embodiments with the features of embodiment A69, comprising a control module configured to measure a travel-time and/or a phase of an acoustic wave and to determine a pressure within the fluid, a viscosity of the fluid and/or a density of the fluid based on the travel time and/or phase of the acoustic wave.
   A77. The mixing assembly according to any of the preceding embodiments with the features of embodiment A69, comprising a control module configured to measure a travel-time and/or a phase of an acoustic wave and to determine a temperature of the fluid based on the travel-time and/or phase of the acoustic wave.
   A78. The mixing assembly according to any of the preceding embodiments with the features of embodiment A69, comprising a control module configured to perform a transmission measurement and/or a phase measurement of an acoustic wave and to determine a conductivity within the fluid based on the transmission measurement and/or the phase measurement of the acoustic wave.
   A79. The mixing assembly according to any of the preceding embodiments with the features of embodiment A70, wherein one of the wave sources is configured as a receiver.
   A80. The mixing assembly according to any of the preceding embodiments with the features of embodiment A70, wherein one of the wave sources is configured to receive an acoustic wave and to simultaneously transmit an acoustic wave.
   A81. The mixing assembly according to any of the preceding embodiments, comprising a mass coating measurement device, configured to determine a mass coating on a surface.
   A82. The mixing assembly according to any of the preceding embodiments with the features of embodiment A81, wherein an inner surface of the fluid accommodation portion is chemically functionalized to facilitate a mass coating measurement at the inner surface.
   A83. The mixing assembly according to any of the preceding embodiments, wherein the wave source is mounted movably to define and control the sound propagation direction and thereby the flow direction in the fluid.
   A84. The mixing assembly according to any of the preceding embodiments with the features of embodiment A41, wherein the transmission material comprises a liquid forming a liquid layer which is configured to multiply reflect an acoustic wave of the wave source at least partially.
   A85. The mixing assembly according to any of the preceding embodiments, wherein the fluid accommodation portion has the form of a sample flask and is removably placeable onto the wave source.
   A86. The mixing assembly according to any of the preceding embodiments, wherein the fluid disposed in the fluid accommodation portion is mixed, and wherein the wave source is configured to shake the fluid in addition to the fluid being mixed.
   A87. The mixing assembly according to any of the preceding embodiments, wherein the wave source comprises a volume oscillator, and wherein the volume oscillator comprises a plurality of stacked volume oscillator modules.
   A88. The mixing assembly according to any of the preceding embodiments with the features of embodiment A6, wherein the piezoelectric substrate is directly processed onto the fluid accommodation portion
   A89. The mixing assembly according to any of the preceding embodiments with the features of embodiment A26, wherein the piston is configured to be excited by the sound wave to mix the fluid within the fluid accommodation portion.
   A90. The mixing assembly according to any of the preceding embodiments with the features of embodiment A27, wherein a component of the pump head is excitable to oscillate by the acoustic wave generated by the wave source.
   A91. The mixing assembly according to any of the preceding embodiments, wherein the fluid accommodation portion comprises an inner surface having an arbitrary shape and wherein the inner surface defines a mixing volume.
   A92. The mixing assembly according to any of the preceding embodiments with the features of embodiment A91, wherein the inner surface is at least partially in contact with the fluid when mixing the fluid.
   A93. The mixing assembly according to any of the preceding embodiments with the features of embodiment A92, comprising inner defining structures, which further define the mixing volume.
   A94. The mixing assembly according to any of the preceding embodiments with the features of embodiment A93, wherein the inner defining structure comprises one of or a plurality of the following shapes: cylinder, cuboid, pyramid, sphere, pore, cone, wherein the inner defining structure is configured to redirect the flow of the fluid to different paths.
   A95. The mixing assembly according to any of the preceding embodiments with the features of embodiment A6, wherein the piezoelectric substrate is directly processed onto the fluid accommodation portion.

Below, system embodiments will be discussed. These embodiments are abbreviated by the letter “S” followed by a number. Whenever reference is herein made to “system embodiments”, these embodiments are meant.

S1. A liquid chromatography system comprising the mixing assembly according to any of the preceding assembly embodiments.
S2. The system according to the preceding embodiment, wherein the system is a high-performance liquid chromatography system.
S3. The system according to the penultimate embodiment, wherein the system is an ion chromatography system.
S4. The system according to any of the preceding system embodiments, comprising a pump head configured to pump and/or pressurize a fluid.
S5. The system according to any of the preceding system embodiments, comprising a plurality of enclosed volumes and wherein a wave source is disposed at each enclosed volume to generate an acoustic wave in the respective enclosed volume.
S6. The system according to any of the preceding system embodiments, comprising a pressured section and section at atmospheric pressure, wherein the wave source is disposed in the section at atmospheric pressure.
S7. The system according to any of the preceding system embodiments, comprising a sampler wherein the wave source is disposed at the sampler at atmospheric pressure to mix a liquid contained within a sample flask disposed in the sampler.
S8. The system according to any of the preceding system embodiments, comprising a fraction collector wherein the wave source is disposed at the fraction collector at atmospheric pressure to mix a liquid contained within a sample flask disposed in the fraction collector.
S9. The system according to any of the preceding system embodiments with the features of embodiment S5, wherein the enclosed volumes are partially filled with liquid and partially filled with a gas in such a manner that a free fluid surface forms between the liquid and the gas, wherein the free fluid surface is deformable by sound and a deformation by sound causes an internal flow.
S10. The system according to any of the preceding system embodiments with the features of embodiment S5, wherein the volumes are configured to contain liquid continuously at any time or are flowed through intermittently.
S11. The liquid chromatography system according to any of the preceding system embodiments with the features of embodiment S4, wherein the pump head comprises a component configured to be excitable to oscillate by the acoustic wave generated by the wave source.
S12. The liquid chromatography system according to any of the preceding system embodiments with the features of embodiment S11, wherein the pump head comprises a piston bore, and wherein the component is disposed within the piston bore in direct contact with the fluid to mix the fluid by means of the oscillation.
S13. The liquid chromatography system according to any of the preceding system embodiments with the features of embodiment S12, wherein the component is disposed freely movable within the piston bore and configured to move translationally and/or periodically, wherein the movement of the component mixes the fluid.
S14. The liquid chromatography system according to any of the preceding system embodiments with the features of embodiment S11, wherein the component is an existing component within the pump head.
S15. The liquid chromatography system according to any of the preceding system embodiments with the features of embodiment S12, wherein the component is piezoelectric and configured to generate a flow inside the piston bore by oscillating, which is used for mixing.
S16. The liquid chromatography system according to any of the preceding system embodiments with the features of embodiment S12, comprising an additional volume, which is disposed in or adjacent and connected to the piston bore, wherein a stroke of a piston into the piston bore does not reach into the additional volume and wherein the fluid is mixed within the additional volume.
S17. The liquid chromatography system according to any of the preceding system embodiments with the features of embodiment S12, wherein an additional volume is disposed in the pump head, and wherein the additional volume is separate from the piston bore, and wherein the fluid is mixed in the additional volume.
S18. The liquid chromatography system according to any of the preceding system embodiments, comprising a mixing volume which is disposed outside of the pump head and/or forms a separate component of the liquid chromatography system.
S19. The liquid chromatography system according to any of the preceding system embodiments, comprising a piston, wherein the fluid accommodation portion comprises an opening, and wherein the piston is insertable into the opening to exert a pressure onto the fluid present in the fluid accommodation portion.
S20. The liquid chromatography system to any of the preceding system embodiments with the features of embodiment S4, wherein the fluid accommodation portion forms a piston chamber, in particular a piston bore, of the pump head.
S21. The liquid chromatography system according to any of the preceding system embodiments with the features of S4, wherein the liquid chromatography system comprises a pump and wherein the pump comprises the fluid accommodation portion.
S22. The liquid chromatography system according to the preceding embodiment, wherein the pump comprises a pump head and wherein the pump head comprises the fluid accommodation portion.
S23. The liquid chromatography system according to any of the preceding system embodiments, comprising two wave sources disposed on a piezoelectric substrate having the form of a chip and comprising a control module configured to measure a travel-time and/or a phase of an acoustic wave generated by at least one of the wave sources and to determine a temperature within the pump head based on the travel-time and/or phase of the acoustic wave.
S24. The liquid chromatography system according to any of the preceding system embodiments, comprising at least one additional volume configured for mixing at least a partial flow of the fluid by the mixing assembly, wherein the additional volume is disposed separate from an unmixed partial flow of the total flow, and wherein the at least two partial flows form a total flow of the same size.
S25. The liquid chromatography system according to any of the preceding system embodiments comprising a fluid container for holding a solvent or a sample, and wherein the fluid container comprises the fluid accommodation portion.
S26. The liquid chromatography system according to any of the preceding system embodiments comprising a high-pressure region forming the fluid accommodation portion.

Below, method embodiments will be discussed. These embodiments are abbreviated by the letter “M” followed by a number. Whenever reference is herein made to “method embodiments”, these embodiments are meant.

M1. A method of mixing a liquid, wherein the method comprises providing a mixing assembly according to any of the preceding assembly embodiments or a liquid chromatography system according to any of the preceding system embodiments, providing a liquid into the liquid accommodation portion, the wave source generating an acoustic wave, injecting at least a part of the acoustic wave into the liquid accommodated in the liquid accommodation portion and thereby mixing the liquid in the liquid accommodation portion.
M2. The method of mixing a liquid according to the preceding embodiment, wherein generating an acoustic wave comprises generating a single mode and/or single frequency ultra-sonic wave.
M3. The method of mixing a liquid according to the penultimate embodiment, wherein generating an acoustic wave comprises generating an ultrasonic wave composed of a plurality of resonant frequencies of the wave source.
M4. The method of mixing a liquid according to any of the preceding method embodiments, wherein injecting the acoustic wave into the liquid comprises refracting an acoustic wave at least partially from the wave source into the liquid accommodation portion and subsequently refracting the acoustic wave at least partially from the liquid accommodation portion into the liquid.
M5. The method of mixing a liquid according to any of the preceding method embodiments, with features of M4, wherein refracting the acoustic wave from the wave source into the liquid accommodation portion comprises refracting the acoustic wave from the wave source into a coupling layer and refracting the acoustic wave from the coupling layer into the liquid accommodation portion.
M6. The method of mixing a liquid according to any of the preceding method embodiments, comprising, compressing and/or pressurizing the fluid disposed in the fluid accommodation portion.
A96. The mixing assembly according to any of the preceding assembly embodiments, wherein the mixing assembly is configured to perform the method according to any of the preceding method embodiments.
S27. The liquid chromatography system according to any of the preceding system embodiments, wherein the liquid chromatography system is configured to perform the method according to any of the preceding method embodiments.

Below, use embodiments will be discussed. These embodiments are abbreviated by the letter “U” followed by a number. Whenever reference is herein made to “use embodiments”, these embodiments are meant.

U1. Use of a mixing assembly according to any of the preceding assembly embodiments or the liquid chromatography system according to any of the preceding system embodiments in a method according to any of the preceding method embodiments.

The present invention will now be described with reference to the accompanying drawings, which illustrate embodiments of the invention. These embodiments should only exemplify, but not limit, the present invention.

FIG. 1 schematically depicts a cross-sectional drawing of an embodiment of a mixing assembly according to the invention.

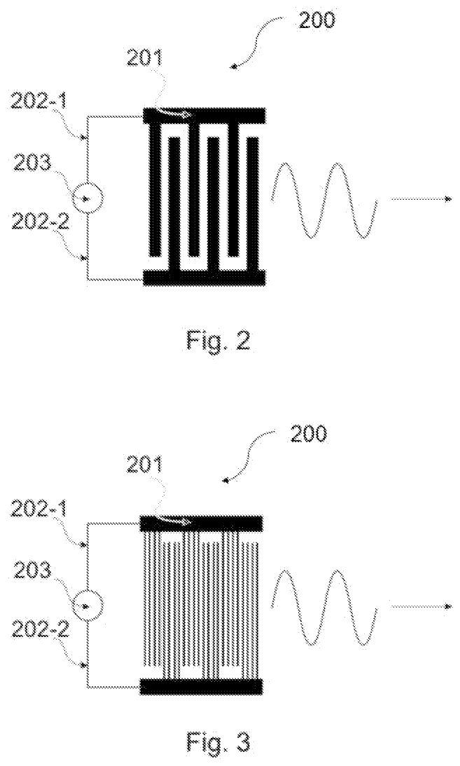

FIG. 2 schematically depicts an embodiment of an electrically conducting structure according to the present invention;

FIG. 3 schematically depicts an embodiment of an electrically conducting structure according to the present invention;

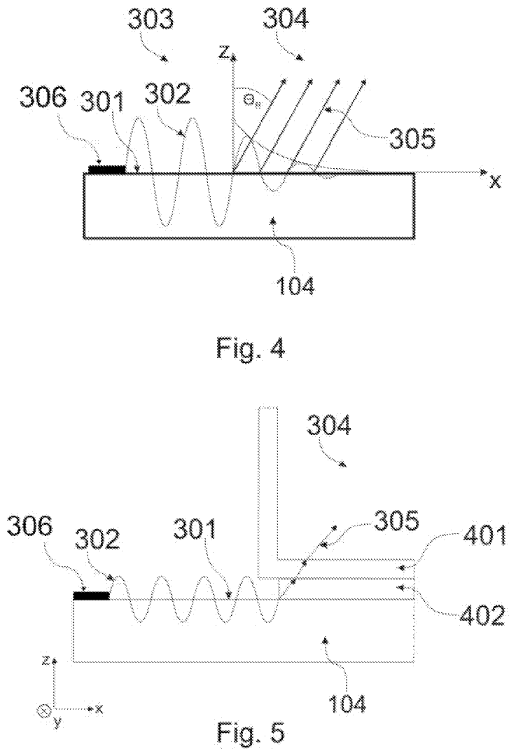

FIG. 4 schematically depicts an embodiment of a transducer according to the present invention;

FIG. 5 schematically depicts an embodiment of a mixing assembly according to the invention;

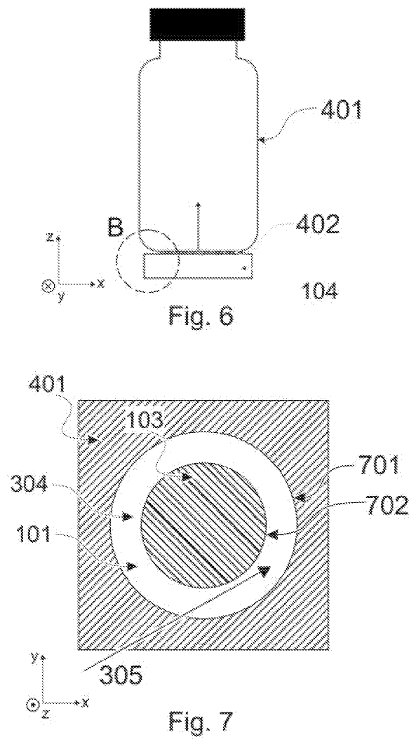

FIG. 6 schematically depicts an embodiment of a mixing assembly according to the invention;

FIG. 7 schematically depicts a cross-sectional drawing of an embodiment of a mixing assembly according to the invention;

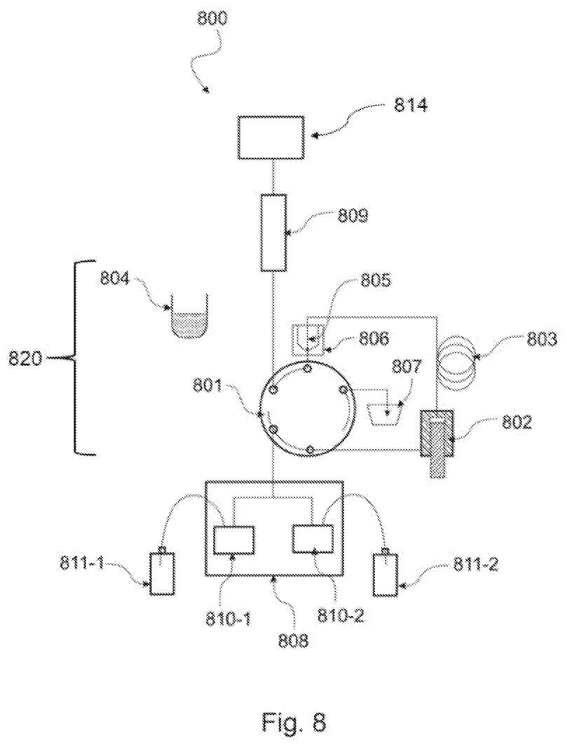

FIG. 8 schematically depicts a drawing of an embodiment of a liquid chromatography system according to the invention;

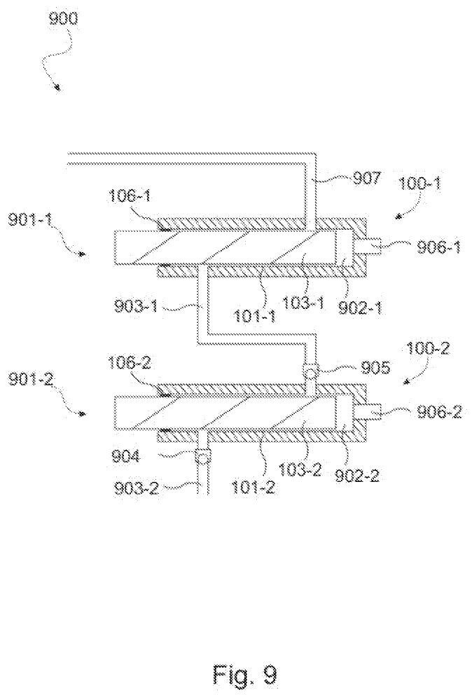

FIG. 9 schematically depicts a drawing of an embodiment of a pump according to the invention; and

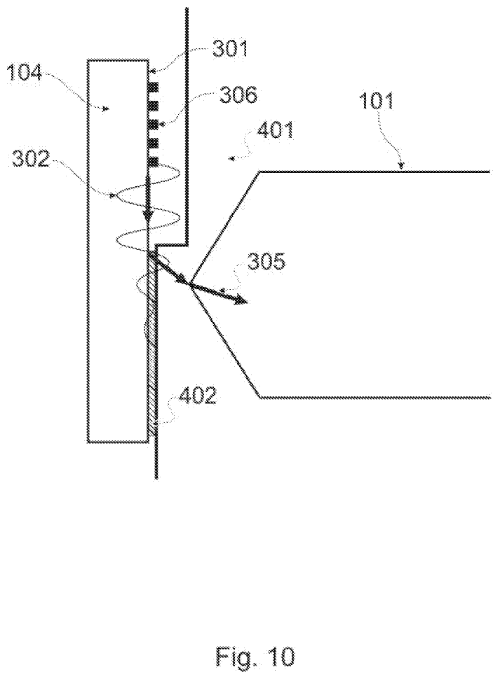

FIG. 10 schematically depicts an embodiment of a mixing assembly according to the invention.

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

High Performance Liquid Chromatography (HPLC) is derived from classical column chromatography. The principle is that a solution of the sample is injected into a column of a porous material (stationary phase) and a liquid (mobile phase) is pumped through the column. The liquid may be pumped through the column at high pressures, e.g., at pressures exceeding 100 bar, preferably exceeding 500 bar, such as exceeding 1000 bar. The separation of sample is based on the differences in the rates of migration through the column arising from different interactions of the sample with the stationary phase. Depending upon the partition behaviour of different components, elution at different time takes place.

FIG. 1 depicts a cross-sectional side view of a piston chamber 101 of a pump head 100. The piston chamber 101 can form a fluid accommodation portion according to an embodiment of the invention. A piston 103 is partially disposed in the piston chamber 101 to compress a fluid disposed in the piston chamber 101 and/or to move the fluid out of the piston chamber 101. The piston chamber 101 and the piston 103 can be sealed by a seal 106 located at a top end opening of the piston chamber 101. Two wave sources 102-1, 102-2 are disposed on outer surfaces 105-1, 105-2 of the piston chamber 101, wherein the wave sources 102-1, 102-2 are oriented perpendicular to one another to vary the transmission of ultrasonic waves into the liquid accordingly. The orientation of the wave source 102-1, 102-2 may partially indicate the propagation direction of a generated acoustic wave into the liquid. However, the actual propagation direction may vary depending on the configuration of the wave source 102-1, 102-2. Exemplary acoustic wave propagation directions are indicated with arrows.

The invention allows fluids, in particular liquids, to be mixed without contact. The wave source 102-1, 102-2 may be located outside of the fluid accommodation portion, and thereby may not be in contact with the fluid. This achieves the advantage of not requiring a sealing system for a mixer. Since the mixing of the fluid can be achieved in a contactless manner, no mixing structure in a fluid volume is required. Mixing by ultrasonic excitation can be achieved in a volume not previously used for this purpose, e.g., the pump head 100 with its piston chamber 101. The pump head 100 can comprise a plurality of piston chambers, preferably two piston chambers. Thereby, no additional mixing volume and/or components are required. This can simplify to achieve chemical compatibility as the number of parts in contact with the fluid can be reduced. Furthermore, no additional volume needs to be added for the mixer.

In the embodiment comprising mixing in the pump, the wave source 102-1 can be placed outside the fluid to be mixed and it may thus not be exposed to a high-pressure region. In particular the liquid within the piston chamber 101 may be compressed and therefore be under a pressure which is orders of magnitudes higher than the atmospheric pressure. Therefore, the wave source 102-1 can be designed based on requirements which do not include high pressure capabilities typically necessary in HPLC applications. Furthermore, a lower standard of insulation can be adopted for electrical leads 202-1, 202-2 (see FIG. 2) connecting the wave source 102-1 to a signal source 203 as the electrical leads 202-1, 202-2 do not need to be shielded from contact with a fluid, respectively liquid. This may reduce the amount seals implemented pertaining to the electrical leads 202-1, 202-2. A schematic drawing of the electrical leads 202-1, 202-2 and the signal source 203 is depicted in FIG. 2. FIG. 2 depicts a transducer supplied with a high frequency alternating current signal, which generates a wave, wherein the transducer is realized in a 1-split structure, thus providing one resonance frequency.

FIG. 2 further depicts an embodiment of an electrically conducting structure 200 which comprises an electrode strand pattern. Thereby, the transducer comprising the electrically conduction structure 201 can be configured as an interdigital transducer (IDT) comprising two interlocking comb-shaped arrays of metallic electrodes (i.e., in the fashion of a zipper). An IDT can generate surface acoustic waves (SAW) by generating periodically distributed mechanical forces via the piezoelectric effect. Each electrode strand may be considered to be a discrete source for the generation of SAWs in the piezoelectric substrate as the piezoelectrically generated stress varies with position near each electrode strand. The electrode strands can be configured in an n-split structure. Shown in FIG. 2 is a 1-split structure. This structure can achieve a bidirectional transmission of an acoustic wave. While this structure transmits a bidirectional wave, only the wave emitted in one direction is usually depicted for simplicity of illustration. FIG. 3 depicts a 4-split structure. To generate several frequencies with the same component, the electrode strands can be split. Thus a 1-split structure can be converted to a 4-split structure to achieve multiple resonant frequencies. A 4-split transducer can generate 4 different frequencies, in particular a base frequency and additionally the third, fifth and seventh harmonic frequency. The electrically conducting structure 201 may partly cover the piezoelectric substrate.

Integrating ultrasonic mixing can achieve the advantage of realizing a reduced fluid volume present in the chromatography pump as mixing and pumping can be achieved in the same volume and without additional space for conventional mixing hardware. Using a smaller fluid volume in the pump, the speed of the sample analysis can be increased. Eliminating the need for a separate mixer simplifies fluid probe handling and increases handling speed. Existing volumes can be used, without the risk of moving components colliding as no additional components are introduced into the fluid volume.

A wave source 101-1, 101-2 comprising a piezoelectric substrate 104 is used to generate an ultrasonic wave 302. A cross-sectional of an embodiment of a piezoelectric substrate 104 is shown in FIG. 4. The piezoelectric substrate 104 forms a chip and a transducer 306, in particular an IDT, comprising an electrically conducting structure 201 (see, e.g., FIG. 2 or FIG. 3) is disposed on a surface 301 of the chip to which a high-frequency electrical signal is applied. Thus, the piezoelectric substrate 104 and the transducer 306 form an ultrasonic wave source.

The electrical signal causes a mechanical disturbance to the piezoelectric substrate 104, and when the transducer 306 is resonantly excited, this creates an acoustic wave that emanates from the transducer 306.

An acoustic wave can travel along the surface 301 of the chip as a surface acoustic wave (SAW) 302. This SAW 302 may travel along the surface 301 as long as the physical boundary conditions remain unchanged, i.e. there is air or vacuum in the upper half-space 303 above the chip. If a liquid 304 is placed on the chip, the acoustic wave decouples from the surface 301 and is refracted into the liquid 304, as is indicated by the wave propagation vectors 305. The acoustic wave traveling through the liquid 304 causes a flow.

This flow can be used for mixing. Sound propagation in the liquid 304 occurs at the Rayleigh angle θ_{R}. The Rayleigh angle θ_{R} is defined by the magnitudes of the sound velocities in the chip substrate vₛ and liquid v_{f}:sin θ_{R}=v_{f}/vₛ.

The sound wave uses typical frequencies from 1 MHz to 1 GHz. The SAW can propagate from left to right along the X-axis. At x=0, it reaches the boundary of the liquid 304 disposed on the surface 301 of the piezoelectric substrate 104. The SAW 302 with an amplitude can then be absorbed by the fluid 304, as is indicated by the decaying amplitude for positive x values. A finite pressure difference 2Δp in the fluid 304 between the ridges and the wells of the acoustic wave 302 is formed, which transforms into a fluid density difference 2Δp. Both quantities spatially and temporally oscillate around their respective equilibrium value p₀, and p₀, respectively. The pressure difference above the surface of the piezoelectric substrate 104 leads to the excitation of a longitudinal acoustic wave into the fluid 304. As the sound velocities for the liquid and the solid substrates are in general not equal, this wave propagates under the Rayleigh angle θ_{R}.

A cross-sectional view of a sample vial 401 disposed on the chip 104 is depicted in FIG. 5. Furthermore, the view shown in FIG. 5 is a schematically reduced crop as marked by B in FIG. 6. When a solid body 401, i.e. a sample vial, is disposed on the chip surface 301, the propagation of an acoustic wave 302 from the surface 301 into the solid body 401 can be impeded. In particular, a gap can form between the adjacent contact surfaces and thus the acoustic wave 302 may not refract toward the solid body 401 due to a poor matching of acoustic impedances and remains in the chip 104. Adding a coupling medium 402, in particular a liquid, in between the adjacent contact surfaces can improve the matching of the acoustic impedances and the acoustic wave 302 can thus better refract through the liquid film 402 into the solid body 401.

The coupling medium 402 can be an adhesive configured to fix the sample vial 401 to the chip surface 301. Alternatively, the solid body 401 can be part of a pump head. Thus, FIG. 5 also shows the sound path in the pump head, where the sound wave couples into the liquid 304 after the path 305. The coupling medium 402 can achieve the advantage of compensating surface unevenness of the solid body 401 and/or the chip 104, respectively the chip surface 301. In particular, air gaps can be prevented, through which the sound wave cannot transmit. Furthermore, using an adhesive as a coupling medium can fixedly attach the chip 104 to the solid body 401.

The solid body 401 can be a fluid accommodation portion having the function of a closed chamber, e.g. a pump head in a pump, a mixer or a sample vial. The acoustic wave 302 propagates through the fluid accommodation portion 401 and then impinges on a volume of liquid 304 enclosed by the solid body, respectively fluid accommodation portion 401. Sample vials as depicted in FIG. 6 can be mixed in a single autosampler but an individualized vial response can be implemented due to the possibility to couple a single vial to its associated transducer, respectively the transducer it is acoustically coupled to. As an alternative to a coupling liquid 402, any type of acoustically coupling material can be disposed between the solid body 401 and the piezoelectric substrate 104. Refraction of the acoustic wave through the coupling liquid 402, solid body 401 and the fluid 304 is indicated by wave propagation vectors 305.

FIG. 7 shows a cross-sectional view of a piston chamber 101 along A-A′ shown in FIG. 1. The piston chamber 101 can be filled with liquid 304. The liquid 304 can, in particular, be disposed between an inner surface 701 of the piston chamber 101 and a mantle surface 702 of the piston 103. It is advantageous to couple the main part of the energy of the acoustic wave with the wave propagation vector 305 into the fluid 304 between the piston 103 and the piston chamber wall 401, respectively between the inner surface 701 and the mantle surface 702. The acoustic wave can be coupled into the wall material of the piston 103 by the wave source.

The mixing assembly according to the invention can be used to mix fluids in HPLC in closed volumes that may be under high pressure. The piston chamber 101 can represent such a closed volume. Using ultrasonic mixing, which may not require additional hardware elements in contact with the liquid, there are no additional components present which could collide with, for example, the piston 103. The piston 103 may be a moving component that constantly changes the size of the volume being mixed. Therefore, the advantage can be achieved that volumes that are spatially variable in size over time can be mixed via ultrasonic waves. It can be advantageous to couple a major part of the energy of the acoustic wave into the liquid 304 between the piston 103 and the wall 701.

The embodiments according to the invention may pertain to a liquid chromatography system 800 as schematically depicted in FIG. 8. In particular FIG. 8 shows exemplary sampler 820 (comprised by the liquid chromatography system 800), wherein the sampler 820 comprises a valve 801, comprising 5 ports and 3 connection elements (although the exact number of ports and connection elements may also be different). The valve 801 may be configured to assume a plurality of configurations. Further, the sampler 820 may comprise a metering device 802 and a sample loop 803, wherein the metering device 802 may be configured to draw fluid, respectively the sample, into the sample loop 803 where it may be stored prior to injection. The sample may for example be drawn from a sample vial 804 by means of a movable needle 805, which may be placed in a needle seat 806 once the sample is in the sample loop 803 in order to guide the sample to components located downstream. The needle 805 and the needle seat 806 may provide a leak tight connection. That is, the sampler 820 may be configured for split-loop operation. Furthermore, the sampler may also comprise a waste reservoir 807, as well as a fluid connection to the second pump 808 and to the first separation column 809, which form part of the liquid chromatography system 800. Downstream of the first separation column 809, the chromatography system may also comprise a detector 814.

The sampler 820 may be configured to enable pre-compression of the sample in the sample loop 803 prior to injecting it into the eluent flow in order to avoid large pressure differences when the sample is injected into the separation column 809. This may be beneficial for avoiding a dispersion of the sample and thus enable a higher reproducibility. Depending on the position of the valve 801, the eluent flow provided by the second pump 808 may directly flow to the first separation column 809 or alternatively it may be guided through the sample loop 803 prior to being guided to the first separation column 809, thereby picking up the stored sample plug.

The pump 808 may comprise two separate pump modules 810-1, 810-2 which are fluidly connected to a respective solvent reservoir 811-1, 811-2. As examples, the mixing assembly according to the invention can be applied within the HPLC system at the following components: pump modules 810-1, 810-2, solvent reservoirs 811-1, 811-2 sample vial 804, and/or metering device 802. Alternatively, the metering device can comprise a pump head onto which a wave source can be disposed to mix the fluid.

It will be appreciated by the person skilled in the art that the depicted and described sampler 820 is merely an example and that other embodiments of a sampler 820 may be utilized in the chromatography system.

Furthermore, when discussing embodiments of the present invention, reference may also be made to the parallel pump depicted in FIG. 9. The pump 900 depicted in this figure comprises a first displacement mechanism 901-1 and a second displacement mechanism 901-2. Each displacement mechanism 901-1, 901-2 comprises a pump head 100-1, 100-2, and a piston 103-1, 103-2 movably mounted in the respective pump head 100-1, 100-2. Thus, there is a free volume 902-1, 902-2 in each of the pump heads 901-1, 901-2. Each piston 103-1, 103-2 is sealed against its respective piston chamber 101-1, 101-2, by means of a seal 106-1, 106-2. Furthermore, each or at least one displacement mechanism 901-1, 901-2 can comprise an inlet 903-2 and an inlet valve assembly 904, as well as an outlet 907 and an outlet valve assembly 905. Further still, in the depicted embodiment, each displacement mechanism 901-1, 901-2 can comprises a pressure senor 906-1, 906-2.

In particular, it should be understood that a pump 900 as depicted in FIG. 9 may be used for each of the pump modules 810-1, 810-2 depicted in FIG. 8. Also with regard to FIG. 9, it is noted that the described mixing assemblies may be located in the first and/or in the second displacement mechanism 901-1, 901-2.

As shown in FIG. 10, the IDT 306 comprising a finger-like electrically conducting structure can generate an acoustic wave (AW) travelling towards a coupling area where the pump head 401 is acoustically coupled to the piezoelectric chip 104 by the coupling medium 402. Initially, the AW can be an SAW.

The AW travels along the chip surface 301, through the coupling medium 402, through the material of the pump head 401 into the piston bore 101 and there into a fluid contained within the piston bore 101. The propagation direction of the AW is indicated with arrows. Transmission losses can be reduced by decreasing the path length of the acoustic wave to the fluid. Therefore, the fluid accommodation portion, respectively the pump head 401, can have a reduced thickness at the entry point or entry surface of the acoustic wave. The energy dissipation from the inner surface of the piston bore 101 can be exponential. Furthermore, an SAW generated on the inner surface of the piston bore 101 may dissipate the majority of its energy in a fluid layer close to the inner surface.

While in the above, preferred embodiments have been described with reference to the accompanying drawings, the skilled person will understand that these embodiments were provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A mixing assembly for mixing a fluid, wherein the mixing assembly comprises
a fluid accommodation portion configured to accommodate the fluid,
a wave source, wherein the wave source is configured to generate an acoustic wave,
wherein the mixing assembly is configured to inject at least part of the acoustic wave into the fluid accommodated in the fluid accommodation portion to thereby cause mixing of the fluid in the fluid accommodation portion.

2. The mixing assembly according to claim 1, wherein
the wave source is configured to generate the acoustic wave with a power in the range of 10 μW to 10 W.

3. The mixing assembly according to any of the preceding claims, wherein the fluid accommodation portion forms a high-pressure chamber, configured to withstand pressures exceeding 100 bar, preferably exceeding 500 bar, such as exceeding 1000 bar.

4. The mixing assembly according to any of the preceding claims,
wherein the wave source comprises a transducer configured to convert an electrical signal into an acoustic wave, in particular an ultrasonic wave,
wherein the piezoelectric substrate has the form of a chip,
wherein the transducer comprises an electrically conducting structure which is disposed on the piezoelectric substrate,
wherein the electrically conducting structure is configured to receive an electrical signal,
wherein the transducer is configured to induce a mechanical displacement of the piezoelectric substrate based on the received electrical signal,
wherein the transducer has at least one resonant vibration mode which is excitable by the electrical signal and wherein the transducer is configured to generate a sound wave when the transducer is excited resonantly on the basis of the electrical signal,
wherein the transducer is configured to generate an acoustic wave (AW),
wherein the fluid accommodation portion is removably disposed on the surface of the chip,
wherein a coupling layer is disposed between the fluid accommodation portion and the surface of the chip, and wherein the coupling layer is configured to increase the matching of an acoustic impedance of the transducer and a further acoustic impedance of the fluid accommodation portion to acoustically couple the transducer and the fluid accommodation portion, and wherein the surface acoustic wave is refracted into the fluid accommodation portion via the coupling layer.

5. The mixing assembly according to any of the preceding claims,
wherein the fluid accommodation portion is configured as a fluid-tight container having at least one opening,
wherein the fluid accommodation portion comprises a solid section and wherein the wave source is disposed on the solid section to inject at least part of the acoustic wave into the fluid via the solid section,
wherein the fluid is in contact with the inner surface and the wave source is disposed on an outer surface of the solid section,
wherein the fluid accommodation portion comprises a wall which is defined by the inner surface and an outer surface,
wherein the mixing assembly comprises a transmission material which is disposed between the wave source and the wall, wherein the transmission material is configured to transmit at least a part of the wave to the wall.

6. The mixing assembly according to any of the preceding claims, wherein the fluid is a liquid, and wherein the mixing assembly is configured for mixing the liquid in a liquid chromatography system, preferably a high-performance liquid chromatography system or an ion chromatography system, and wherein the liquid chromatography system comprises a pump and wherein the pump comprises the fluid accommodation portion.

7. The mixing assembly according to any of claims 1 to 5, wherein the fluid is a liquid, and wherein the mixing assembly is configured for mixing the liquid in a liquid chromatography system, preferably a high-performance liquid chromatography system or an ion chromatography system, wherein the liquid chromatography system comprises a fluid container for holding a solvent or a sample, and wherein the fluid container comprises the fluid accommodation portion.

8. A liquid chromatography system comprising the mixing assembly according to any of the preceding claims.

9. A method of mixing a liquid, wherein the method comprises
providing a mixing assembly according to any of the claims 1 to 7 or a liquid chromatography system according to claim 8,
providing a liquid into the liquid accommodation portion,
the wave source generating an acoustic wave,
injecting at least a part of the acoustic wave into the liquid accommodated in the liquid accommodation portion and thereby mixing the liquid in the liquid accommodation portion.

10. Use of the mixing assembly according to any of the claims 1 to 7 or the liquid chromatography system according to claim 8 in a method according to claim 9.
